(19) United States
(12) Patent Application Publication
(10) Pub. No.: US 2022/0050337 A1
(43) Pub. Date: Feb. 17, 2022

(54) LIQUID CRYSTAL DISPLAY PANEL AND METHOD FOR MANUFACTURING SAME

(71) Applicants: SAKAI DISPLAY PRODUCTS CORPORATION, Sakai-shi, Osaka (JP); SHARP KABUSHIKI KAISHA, Sakai City, Osaka (JP)

(72) Inventors: MITSUAKI HIRATA, Sakai-shi, Osaka (JP); FUMIKAZU SHIMOSHIKIRYOH, Sakai City, Osaka (JP)

(21) Appl. No.: 17/276,065

(22) PCT Filed: Sep. 14, 2018
(86) PCT No.: PCT/JP2018/034257

§ 371 Date: Mar. 12, 2021

(51) Int. Cl. G02F 1/1337; G02F 1/1343

(52) U.S. Cl. CPC G02F 1/133742; G02F 1/134309; G02F 1/133761; G02F 1/133757; G02F 1/133749; G02F 1/133746

(57) ABSTRACT

The liquid crystal display panel includes a first vertical alignment film (20), a liquid crystal layer (30), and a second vertical alignment film (40). First and second high-pretilt angle regions (21a, 21b) of the first vertical alignment film (20) are opposed to first and second high-pretilt angle regions (41a, 41b) of the second vertical alignment film (40), and are shorter in length than the first and second high-pretilt angle regions (41a, 41b) of the second vertical alignment film (40) in a direction along the longitudinal direction of the pixel region 101. First and second high-pretilt angle regions (23a, 23b) of the first vertical alignment film (20) are opposed to first and second high-pretilt angle regions (43a, 43b) of the second vertical alignment film (40), and are shorter in length than the first and second high-pretilt angle regions (43a, 43b) of the second vertical alignment film (40) in the direction along the longitudinal direction of the pixel region (101).

### TECHNICAL FIELD

This invention relates to a liquid crystal display panel, and a production method for this liquid crystal display panel.

### BACKGROUND ART

One conventional liquid crystal display panel is that which is disclosed in Japanese Patent No. 5203601. In this liquid crystal display panel, a pixel region corresponding to one pixel in terms of displaying includes four liquid crystal domains in which liquid crystal molecules have respectively different alignment directions. In other words, the aforementioned liquid crystal display panel has a so-called alignment division structure. Moreover, each such liquid crystal domain is interposed between a pair of alignment films.

In producing a liquid crystal display panel of the above configuration, each alignment film is subjected to two instances of light irradiation in order to obtain an alignment division structure.

To describe this more specifically, after a portion of one of the alignment films is subjected to a first instance of light irradiation by using a photomask, the photomask is moved in order to perform a second instance of light irradiation for another portion of the alignment film in a direction different from that in the first instance of light irradiation. At this time, in order to prevent an unexposed region from being created, it is ensured that the second instance of light irradiation is also applied to a part of the exposed region that was formed through the first instance of light irradiation. As a result of this, the one alignment film acquires a double-exposed region that has been formed with two kinds of light which have respectively different irradiation directions.

Thereafter, third and fourth instances of light irradiation are performed for the other alignment film. At this time, the direction of the third instance of light irradiation differs from the direction of the fourth instance of light irradiation. Moreover, in order to prevent an unexposed region, the fourth instance of light irradiation is performed in a similar manner to the second instance of light irradiation. As a result of this, the other alignment film acquires a double-exposed region that has been formed with two kinds of light which have respectively different irradiation directions.

### CITATION LIST

### Patent Literature

[Patent Document 1] Japanese Patent No. 5203601

### SUMMARY OF INVENTION

### Technical Problem

In the aforementioned double-exposed region, performing light irradiation in different directions cancels out the effect of conferring a pretilt, and a high pretilt angle results in a poor force of regulating the alignment of liquid crystal molecules. Therefore, it is preferable that the double-exposed region provided on one of the pair of alignment films is opposed to the double-exposed region provided on the other of the pair of alignment films.

However, deviations in position due to manufacturing errors, etc., may occur that prevent these double-exposed regions from being opposed to each other. If this happens, a problem may result in that dark lines occurring when light is transmitted through the pixel region may increase in geometric area.

Therefore, a challenge in this invention is to provide a liquid crystal display panel that can suppress an increase in the geometric area of dark lines to occur when light is transmitted through the pixel region, and a production method for the same.

### Solution to Problem

A liquid crystal display panel according to one implementation of this invention is a liquid crystal display panel having a display mode that is a VA mode and including a plurality of rectangular-shaped pixel regions, comprising:

a first substrate section including a first substrate and pixel electrodes provided above the first substrate;

a liquid crystal layer being provided above the first substrate section and containing liquid crystal molecules;

a first vertical alignment film provided between the first substrate section and the liquid crystal layer;

a second substrate section being provided above the liquid crystal layer and including a second substrate and a counter electrode provided below the second substrate; and

a second vertical alignment film provided between the second substrate section and the liquid crystal layer, wherein,

a portion of the liquid crystal layer corresponding to each pixel region includes a first liquid crystal domain, a second liquid crystal domain, a third liquid crystal domain, and a fourth liquid crystal domain arranged along a longitudinal direction of the pixel region;

when a direction orthogonal to the longitudinal direction of the pixel region is defined as a transverse direction of the pixel and an azimuth flush with the transverse direction of the pixel region is defined as 0°, then an alignment azimuth of the liquid crystal molecules in the first liquid crystal domain is substantially 315°; an alignment azimuth of the liquid crystal molecules in the second liquid crystal domain is substantially 45°; an alignment azimuth of the liquid crystal molecules in the third liquid crystal domain is substantially 225°; and an alignment azimuth of the liquid crystal molecules in the fourth liquid crystal domain is substantially 135°;

the first vertical alignment film includes a first lower alignment regulating portion, a second lower alignment regulating portion, a third lower alignment regulating portion, and a fourth lower alignment regulating portion to regulate alignments of the liquid crystal molecules in the first liquid crystal domain, the second liquid crystal domain, the third liquid crystal domain, and the fourth liquid crystal domain from below;

the second vertical alignment film includes a first upper alignment regulating portion, a second upper alignment regulating portion, a third upper alignment regulating portion, and a fourth upper alignment regulating portion to regulate alignments of the liquid crystal molecules in the first liquid crystal domain, the second liquid crystal domain, the third liquid crystal domain, and the fourth liquid crystal domain from above;

the first and third lower alignment regulating portions and the first and third upper alignment regulating portions, or the second and fourth lower alignment regulating portions and the second and fourth upper alignment regulating portions each include

a first high-pretilt angle region provided at one side in a direction along the longitudinal direction of the pixel region,

a second high-pretilt angle region provided at another side in the direction along the longitudinal direction of the pixel region, and

a low-pretilt angle region being provided between the first high-pretilt angle region and the second high-pretilt angle region and having a smaller pretilt angle than do the first and second high-pretilt angle regions;

when the first and third lower alignment regulating portions and the first and third upper alignment regulating portions each include the first and second high-pretilt angle regions and the low-pretilt angle region,

the first and second high-pretilt angle regions of the first lower alignment regulating portion are opposed to the first and second high-pretilt angle regions of the first upper alignment regulating portion, and are shorter in length than the first and second high-pretilt angle regions of the first upper alignment regulating portion in the direction along the longitudinal direction of the pixel region; and

the first and second high-pretilt angle regions of the third lower alignment regulating portion are opposed to the first and second high-pretilt angle regions of the third upper alignment regulating portion, and are shorter in length than the first and second high-pretilt angle regions of the third upper alignment regulating portion in the direction along the longitudinal direction of the pixel region; and

when the second and fourth lower alignment regulating portions and the second and fourth upper alignment regulating portions each include the first and second high-pretilt angle regions and the low-pretilt angle region,

the first and second high-pretilt angle regions of the second lower alignment regulating portion are opposed to the first and second high-pretilt angle regions of the second upper alignment regulating portion, and are shorter in length than the first and second high-pretilt angle regions of the second upper alignment regulating portion in the direction along the longitudinal direction of the pixel region; and

the first and second high-pretilt angle regions of the fourth lower alignment regulating portion are opposed to the first and second high-pretilt angle regions of the fourth upper alignment regulating portion, and are shorter in length than the first and second high-pretilt angle regions of the fourth upper alignment regulating portion in the direction along the longitudinal direction of the pixel region.

Herein, the aforementioned alignment azimuth of a liquid crystal molecule refers to, in a plan view of the liquid crystal molecule under an applied voltage across the liquid crystal layer, a direction from one end of the liquid crystal molecule along its major axis direction that is at the first substrate section side to the other end of the liquid crystal molecule along its major axis direction that is at the second substrate section side. In this case, when the alignment azimuth of a liquid crystal molecule is said to be 0°, this alignment azimuth corresponds to the rightward direction from one end of the liquid crystal molecule along its major axis direction that is at the first substrate section side (so-called the 3 o'clock direction). In that case, when the alignment azimuth of a liquid crystal molecule is said to be 45°, this alignment azimuth corresponds to an alignment azimuth that results through a 45° counterclockwise rotation from the 0° alignment azimuth of the liquid crystal molecule.

As referred to above, substantially 45° means an angle in the range from 30° to 60°, or an angle in the range from 40° to 50°. As referred to above, substantially 135° means an angle in the range from 150° to 120°, or an angle in the range from 140° to 130°. As referred to above, substantially 225° means an angle in the range from 210° to 240°, or an angle in the range from 220° to 230°. As referred to above, substantially 315° means an angle in the range from 300° to 330°, or an angle in the range from 310° to 320°.

Moreover, the aforementioned pretilt angle means, in an interface which is in contact with an alignment regulating portion of the liquid crystal layer, a tilt angle of molecular orientation with respect to a plane that is orthogonal to the thickness direction of the liquid crystal layer.

A production method for a liquid crystal display panel according to one implementation of this invention is a production method for a liquid crystal display panel having a display mode that is a VA mode and including a plurality of rectangular-shaped pixel regions, the liquid crystal display panel including:

a first substrate section including a first substrate and pixel electrodes provided above the first substrate;

a liquid crystal layer being provided above the first substrate section and containing liquid crystal molecules;

a first vertical alignment film provided between the first substrate section and the liquid crystal layer;

a second substrate section being provided above the liquid crystal layer and including a second substrate and a counter electrode provided below the second substrate; and

a second vertical alignment film provided between the second substrate section and the liquid crystal layer, wherein,

a portion of the liquid crystal layer corresponding to each pixel region includes a first liquid crystal domain, a second liquid crystal domain, a third liquid crystal domain, and a fourth liquid crystal domain arranged along a longitudinal direction of the pixel region;

when a direction orthogonal to the longitudinal direction of the pixel region is defined as a transverse direction of the pixel and an azimuth flush with the transverse direction of the pixel region is defined as 0°, then an alignment azimuth of the liquid crystal molecules in the first liquid crystal domain is substantially 315°; an alignment azimuth of the liquid crystal molecules in the second liquid crystal domain is substantially 45°; an alignment azimuth of the liquid crystal molecules in the third liquid crystal domain is substantially 225°; and an alignment azimuth of the liquid crystal molecules in the fourth liquid crystal domain is substantially 135°;

the first vertical alignment film includes a first lower alignment regulating portion, a second lower alignment regulating portion, a third lower alignment regulating portion, and a fourth lower alignment regulating portion to regulate alignments of the liquid crystal molecules in the first liquid crystal domain, the second liquid crystal domain, the third liquid crystal domain, and the fourth liquid crystal domain from below;

the second vertical alignment film includes a first upper alignment regulating portion, a second upper alignment regulating portion, a third upper alignment regulating portion, and a fourth upper alignment regulating portion to regulate alignments of the liquid crystal molecules in the first liquid crystal domain, the second liquid crystal domain, the third liquid crystal domain, and the fourth liquid crystal domain from above; and

the first and third lower alignment regulating portions and the first and third upper alignment regulating portions each include

a first high-pretilt angle region provided at one side in a direction along the longitudinal direction of the pixel region,

a second high-pretilt angle region provided at another side in the direction along the longitudinal direction of the pixel region, and

a low-pretilt angle region being provided between the first high-pretilt angle region and the second high-pretilt angle region and having a smaller pretilt angle than do the first and second high-pretilt angle regions, the production method comprising:

a step of forming the first vertical alignment film and the second vertical alignment film so that the first and second high-pretilt angle regions of the first lower alignment regulating portion are shorter in length than the first and second high-pretilt angle regions of the first upper alignment regulating portion in the direction along the longitudinal direction of the pixel region, and that the first and second high-pretilt angle regions of the third lower alignment regulating portion are shorter in length than the first and second high-pretilt angle regions of the third upper alignment regulating portion in the direction along the longitudinal direction of the pixel region; and

a step of, after the step of forming the first vertical alignment film and the second vertical alignment film is performed, disposing the second substrate on the first substrate section via the liquid crystal layer so that the first and second high-pretilt angle regions of the first lower alignment regulating portion are opposed to the first and second high-pretilt angle regions of the first upper alignment regulating portion, and that the first and second high-pretilt angle regions of the third lower alignment regulating portion are opposed to the first and second high-pretilt angle regions of the third upper alignment regulating portion.

Herein, the aforementioned alignment azimuth of a liquid crystal molecule refers to, in a plan view of the liquid crystal molecule under an applied voltage across the liquid crystal layer, a direction from one end of the liquid crystal molecule along its major axis direction that is at the first substrate section side to the other end of the liquid crystal molecule along its major axis direction that is at the second substrate section side. In this case, when the alignment azimuth of a liquid crystal molecule is said to be 0°, this alignment azimuth corresponds to the rightward direction from one end of the liquid crystal molecule along its major axis direction that is at the first substrate section side (so-called the 3 o'clock direction). In that case, when the alignment azimuth of a liquid crystal molecule is said to be 45°, this alignment azimuth corresponds to an alignment azimuth that results through a 45° counterclockwise rotation from the 0° alignment azimuth of the liquid crystal molecule.

As referred to above, substantially 45° means an angle in the range from 30° to 60°, or an angle in the range from 40° to 50°. As referred to above, substantially 135° means an angle in the range from 150° to 120°, or an angle in the range from 140° to 130°. As referred to above, substantially 225° means an angle in the range from 210° to 240°, or an angle in the range from 220° to 230°. As referred to above, substantially 315° means an angle in the range from 300° to 330°, or an angle in the range from 310° to 320°.

Moreover, the aforementioned pretilt angle means, in an interface which is in contact with an alignment regulating portion of the liquid crystal layer, an angle of alignment of molecular orientation with respect to a plane that is orthogonal to the thickness direction of the liquid crystal layer.

A production method for a liquid crystal display panel according to one implementation of this invention is a production method for a liquid crystal display panel having a display mode that is a VA mode and including a plurality of rectangular-shaped pixel regions, the liquid crystal display panel including:

a first substrate section including a first substrate and pixel electrodes provided above the first substrate;

a liquid crystal layer being provided above the first substrate section and containing liquid crystal molecules;

a first vertical alignment film provided between the first substrate section and the liquid crystal layer;

a second substrate section being provided above the liquid crystal layer and including a second substrate and a counter electrode provided below the second substrate; and

a second vertical alignment film provided between the second substrate section and the liquid crystal layer, wherein,

a portion of the liquid crystal layer corresponding to each pixel region includes a first liquid crystal domain, a second liquid crystal domain, a third liquid crystal domain, and a fourth liquid crystal domain arranged along a longitudinal direction of the pixel region;

when a direction orthogonal to the longitudinal direction of the pixel region is defined as a transverse direction of the pixel and an azimuth flush with the transverse direction of the pixel region is defined as 0°, then an alignment azimuth of the liquid crystal molecules in the first liquid crystal domain is substantially 315°; an alignment azimuth of the liquid crystal molecules in the second liquid crystal domain is substantially 45°; an alignment azimuth of the liquid crystal molecules in the third liquid crystal domain is substantially 225°; and an alignment azimuth of the liquid crystal molecules in the fourth liquid crystal domain is substantially 135°;

the first vertical alignment film includes a first lower alignment regulating portion, a second lower alignment regulating portion, a third lower alignment regulating portion, and a fourth lower alignment regulating portion to regulate alignments of the liquid crystal molecules in the first liquid crystal domain, the second liquid crystal domain, the third liquid crystal domain, and the fourth liquid crystal domain from below;

the second vertical alignment film includes a first upper alignment regulating portion, a second upper alignment regulating portion, a third upper alignment regulating portion, and a fourth upper alignment regulating portion to regulate alignments of the liquid crystal molecules in the first liquid crystal domain, the second liquid crystal domain, the third liquid crystal domain, and the fourth liquid crystal domain from above; and

the second and fourth lower alignment regulating portions and the second and fourth upper alignment regulating portions each include

a first high-pretilt angle region provided at one side in a direction along the longitudinal direction of the pixel region,

a second high-pretilt angle region provided at another side in the direction along the longitudinal direction of the pixel region, and

a low-pretilt angle region being provided between the first high-pretilt angle region and the second high-pretilt angle region and having a smaller pretilt angle than do the first and second high-pretilt angle regions, the production method comprising:

a step of forming the first vertical alignment film and the second vertical alignment film so that the first and second high-pretilt angle regions of the second lower alignment regulating portion are shorter in length than the first and second high-pretilt angle regions of the second upper alignment regulating portion in the direction along the longitudinal direction of the pixel region, and that the first and second high-pretilt angle regions of the fourth lower alignment regulating portion are shorter in length than the first and second high-pretilt angle regions of the fourth upper alignment regulating portion in the direction along the longitudinal direction of the pixel region; and

a step of, after the step of forming the first vertical alignment film and the second vertical alignment film is performed, disposing the second substrate on the first substrate section via the liquid crystal layer so that the first and second high-pretilt angle regions of the second lower alignment regulating portion are opposed to the first and second high-pretilt angle regions of the second upper alignment regulating portion, and that the first and second high-pretilt angle regions of the fourth lower alignment regulating portion are opposed to the first and second high-pretilt angle regions of the fourth upper alignment regulating portion.

Herein, the aforementioned alignment azimuth of a liquid crystal molecule refers to, in a plan view of the liquid crystal molecule under an applied voltage across the liquid crystal layer, a direction from one end of the liquid crystal molecule along its major axis direction that is at the first substrate section side to the other end of the liquid crystal molecule along its major axis direction that is at the second substrate section side. In this case, when the alignment azimuth of a liquid crystal molecule is said to be 0°, this alignment azimuth corresponds to the rightward direction from one end of the liquid crystal molecule along its major axis direction that is at the first substrate section side (so-called the 3 o'clock direction). In that case, when the alignment azimuth of a liquid crystal molecule is said to be 45°, this alignment azimuth corresponds to an alignment azimuth that results through a 45° counterclockwise rotation from the 0° alignment azimuth of the liquid crystal molecule.

As referred to above, substantially 45° means an angle in the range from 30° to 60°, or an angle in the range from 40° to 50°. As referred to above, substantially 135° means an angle in the range from 150° to 120°, or an angle in the range from 140° to 130°. As referred to above, substantially 225° means an angle in the range from 210° to 240°, or an angle in the range from 220° to 230°. As referred to above, substantially 315° means an angle in the range from 300° to 330°, or an angle in the range from 310° to 320°.

Moreover, the aforementioned pretilt angle means, in an interface which is in contact with an alignment regulating portion of the liquid crystal layer, an angle of alignment of molecular orientation with respect to a plane that is orthogonal to the thickness direction of the liquid crystal layer.

### Advantageous Effects of Invention

With the above-described configuration, a liquid crystal display panel and a production method for the same according to this invention can suppress an increase in the geometric area of dark lines to occur when light is transmitted through the pixel region.

### BRIEF DESCRIPTION OF DRAWINGS

FIG. 1 A schematic cross-sectional view of a liquid crystal display panel according to a first embodiment of the present invention.

FIG. 2 A schematic plan view of the liquid crystal display panel according to the first embodiment.

FIG. 3 A schematic perspective view for describing the attitudes of liquid crystal molecules according to the first embodiment.

FIG. 4 An enlarged plan view of a pixel electrode according to the first embodiment and its neighborhood.

FIG. 5 A schematic cross-sectional view of a first and second vertical alignment films and a liquid crystal layer according to the first embodiment.

FIG. 6 A schematic diagram for describing a production step for a liquid crystal display panel according to the first embodiment.

FIG. 7 A schematic diagram for describing a production step following the production step in FIG. 6.

FIG. 8 A schematic diagram for describing a production step following the production step in FIG. 7.

FIG. 9 A schematic diagram for describing a production step following the production step in FIG. 8.

FIG. 10 A schematic diagram for describing a production step following the production step in FIG. 9.

FIG. 11 A schematic diagram for describing a production step following the production step in FIG. 10.

FIG. 12 A schematic diagram for describing a production step following the production step in FIG. 11.

FIG. 13 A schematic diagram for describing a production step following the production step in FIG. 12.

FIG. 14 A photographic representation of a simulation of dark lines in the first embodiment.

FIG. 15 Another photographic representation of a simulation of dark lines in the first embodiment.

FIG. 16 Another photographic representation of a simulation of dark lines in the first embodiment.

FIG. 17 A schematic cross-sectional view of first and second vertical alignment films and a liquid crystal layer according to a first comparative example.

FIG. 18 A photographic representation of a simulation of dark lines in the first comparative example.

FIG. 19 Another photographic representation of a simulation of dark lines in the first comparative example.

FIG. 20 Another photographic representation of a simulation of dark lines in the first comparative example.

FIG. 21 A photographic representation of a simulation of dark lines in a variation.

FIG. 22 Another photographic representation of a simulation of dark lines in the aforementioned variation.

FIG. 23 Another photographic representation of a simulation of dark lines in the aforementioned variation.

FIG. 24 A photographic representation of a simulation of dark lines in a second comparative example.

FIG. 25 Another photographic representation of a simulation of dark lines in the second comparative example.

FIG. 26 Another photographic representation of a simulation of dark lines in the second comparative example.

FIG. 27 A schematic cross-sectional view of first and second vertical alignment films and a liquid crystal layer according to a second embodiment of this invention.

FIG. 28 A schematic diagram for describing a production step for a liquid crystal display panel according to the second embodiment.

FIG. 29 A schematic diagram for describing a production step following the production step in FIG. 28.

FIG. 30 A schematic diagram for describing a production step following the production step in FIG. 29.

FIG. 31 A schematic diagram for describing a production step following the production step in FIG. 30.

### DESCRIPTION OF EMBODIMENTS

Hereinafter, by way of embodiments illustrated in the drawings, liquid crystal display panels according to this invention and production methods for the same will be described in more detail. In the drawings, common portions are denoted by like numerals, with any redundant description being omitted.

### First Embodiment

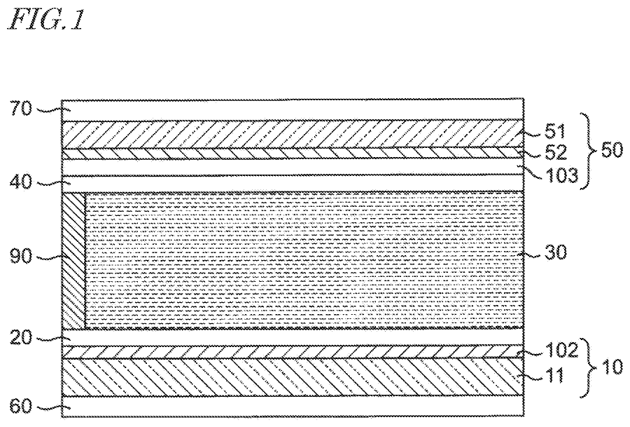

FIG. 1 is a cross-sectional view schematically showing a cross section of a liquid crystal display panel according to a first embodiment of this invention.

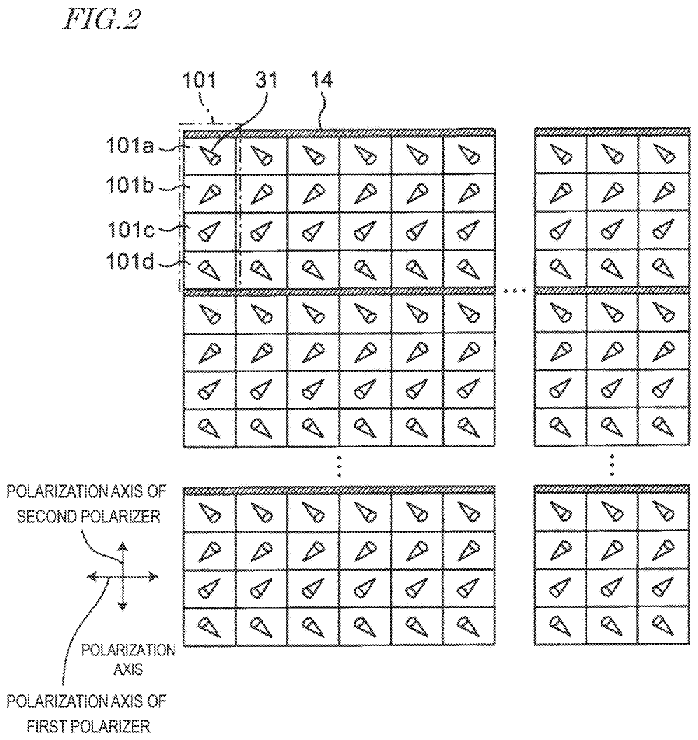

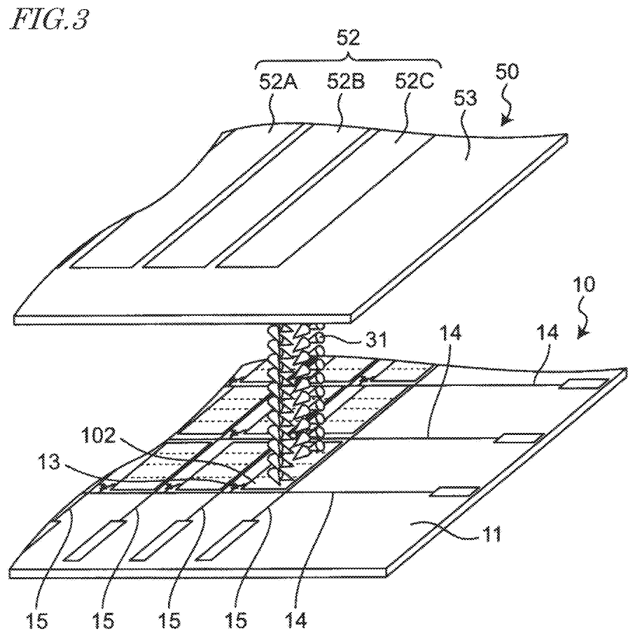

The liquid crystal display panel is a liquid crystal display panel whose display mode is a VA mode, including: a first substrate section 10; a first vertical alignment film 20; a liquid crystal layer 30 containing liquid crystal molecules 31 (shown in FIG. 2 and FIG. 3); a second vertical alignment film 40; and a second substrate section 50. The first vertical alignment film 20, the liquid crystal layer 30, the second vertical alignment film 40, and the second substrate section 50 are stacked in this order on the first substrate section 10. Between the first vertical alignment film 20 and the second vertical alignment film 40, a sealing member 90 with which to seal the liquid crystal layer 30 is provided. Herein, light from the first substrate section 10 side passes through the liquid crystal layer 30, and thereafter travels toward the second substrate section 50 side. In other words, the aforementioned light enters into the liquid crystal display panel and then goes out from the liquid crystal display panel at the second substrate section 50 side.

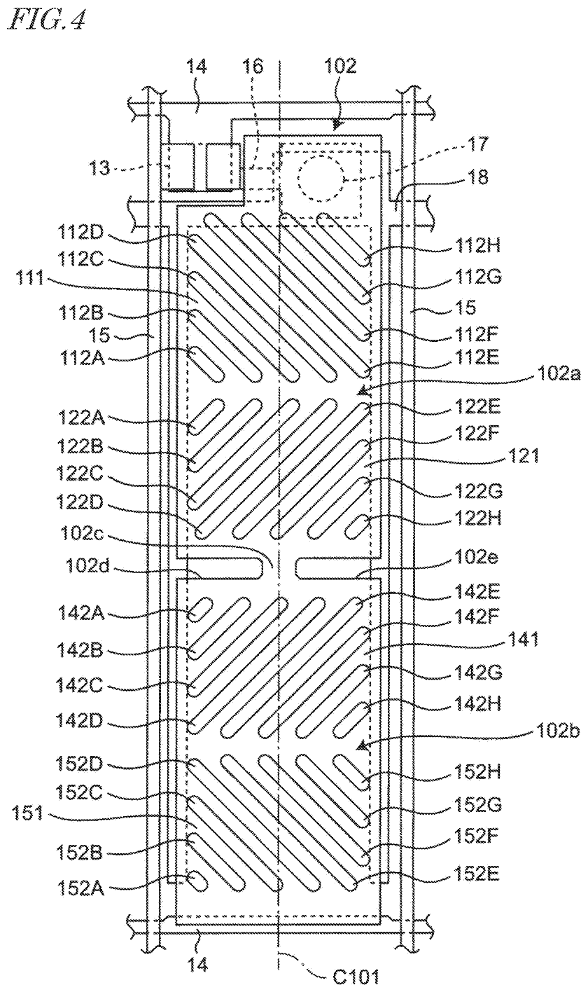

The first substrate section 10 includes a first glass substrate 11 and pixel electrodes 102 provided on an upper surface of the first glass substrate 11. Also, thin film transistors 13 (shown in FIG. 3 and FIG. 4) are provided on the upper surface of the first glass substrate 11, the thin film transistors 13 being electrically connected to the pixel electrodes 102. Under the first substrate section 10, a first polarizer 60 is disposed. Note that the first glass substrate 11 is an example of a first substrate.

The first and second vertical alignment films 20 and 40 are made of a material showing a photo-alignment property. This material showing a photo-alignment property generally refers to any material which, as it is irradiated with ultraviolet light, visible light, or other light (electromagnetic waves), undergoes a structural change to exhibit a nature of regulating the alignment of liquid crystal molecules that are in its neighborhood (alignment regulating force), or which undergoes a change in terms of at least one of the magnitude of alignment regulating force and the direction of alignment regulating force. Examples of such materials include a photoreactive site at which a reaction such as dimerization (dimer formation), isomerization, photo-Fries rearrangement, or decomposition may occur in response to light irradiation. Examples of photoreactive sites (functional groups) that undergo dimerization and isomerization in response to light irradiation include cinnamates, 4-chalcone, 4-1-chalcone, coumarin, stilbene, and the like. Examples of photoreactive sites (functional groups) that undergo isomerization in response to light irradiation include azobenzene and the like. Examples of photoreactive sites that undergo photo-Fries rearrangement in response to light irradiation include phenolic ester structures and the like. Examples of photoreactive sites that undergo decomposition in response to light irradiation include cyclobutane structures and the like. Note that the first and second vertical alignment films 20 and 40 may also be made of a material other than materials showing a photo-alignment property.

The second substrate section 50 includes a second glass substrate 51, a color filter 52, and a counter electrode 103. Along the thickness direction of the second glass substrate 51, the color filter 52 is opposed to the pixel electrodes 102. On the second substrate section 50, a second polarizer 70 having a polarization axis that is orthogonal to a polarization axis (transmission axis) of the first polarizer 60 is disposed. Note that the second glass substrate 51 is an example of a second substrate.

The pixel electrodes 102 and the counter electrode 103 may each be a transparent electrode of ITO (Indium Tin Oxide), for example. Moreover, the counter electrode 103 is made of a single electrode layer that is unslitted. FIG. 1 illustrates the pixel electrode 102 as if composed of a single electrode layer as the counter electrode 103 is; in actuality, however, a plurality of pixel electrodes 102 in FIG. 4 are formed on the first substrate section 10.

FIG. 2 is a plan view schematically showing the liquid crystal display panel. In FIG. 2, liquid crystal molecules 41 under an applied voltage across the liquid crystal layer 30 are depicted by cone shapes. More specifically, one end of each liquid crystal molecule 31 along its major axis direction that corresponds to the apex of the cone is located at the first substrate section 10 side. On the other hand, the other end of each liquid crystal molecule 31 along the major axis direction that corresponds to the bottom of the cone is located at the second substrate section 50 side.

In the above liquid crystal display panel, a plurality of rectangular-shaped pixel regions 101 are arranged in a matrix. Each pixel region 101 includes four first, second, third and fourth liquid crystal domains 101a 101b, 101c and 101d, which differ from one another in terms of the alignment azimuth of the liquid crystal molecules 31. Moreover, the first, second, third and fourth liquid crystal domains 101a 101b, 101c and 101d are arranged along the longitudinal direction of the pixel region 101 (i.e., the up-down direction in FIG. 2). Note that each pixel region 101 is a region of the liquid crystal panel corresponding to one pixel in terms of displaying. Moreover, a pixel as aforementioned refers to a smallest unit that expresses a particular gray scale level, and in color displaying, corresponds to a unit that expresses a gray scale level in red, green, or blue for example. Such a pixel corresponding to a unit expressing a gray scale level in red, a pixel corresponding to a unit expressing a gray scale level in green, and a pixel corresponding to a unit expressing a gray scale level in blue constitute a single color-displaying pixel.

When the liquid crystal display panel is viewed from the second substrate section 50 side, assuming that a direction from one end of the liquid crystal molecule 31 along its major axis direction toward the right-hand side in FIG. 2 is defined as 0°, then an alignment azimuth of the liquid crystal molecules 31 in the first liquid crystal domain 101a is substantially 315°; an alignment azimuth of the liquid crystal molecules 31 in the second liquid crystal domain 101b is substantially 45°; an alignment azimuth of the liquid crystal molecules 31 in the third liquid crystal domain 101c is substantially 225°; and an alignment azimuth of the liquid crystal molecules 31 in the fourth liquid crystal domain 101d is substantially 135°. These alignment azimuths may be conferred by irradiating a photoalignment film with polarized UV light through a mask, for example.

Moreover, in order to enhance the transmittance of the liquid crystal layer 30, the transverse direction of the pixel region 101 is set so as to be parallel to the polarization axis of the first polarizer 60.

Herein, the aforementioned alignment azimuth is an orientation that does not take into account any angle of alignment with respect to the normal direction of the upper surface of the first glass substrate 11. More specifically, the aforementioned alignment azimuth means a direction in which the other end (i.e., the end at the second substrate section 50 side) of the liquid crystal molecule 31 along its major axis direction is oriented, when the liquid crystal molecule 31 is projected onto the upper surface of the first glass substrate 11, i.e., when the liquid crystal molecule 31 is viewed from the second substrate section 50 side. For example, the liquid crystal molecule 31 are arranged so that: if the crystal orientation of a liquid crystal molecule 31 is 10°, when that liquid crystal molecule 31 is viewed from the second substrate section 50 side, the other end of the liquid crystal molecule 31 along its major axis direction constitutes 10° with respect to a direction parallel to the transverse direction of the pixel region 101. Note that any angle in a counterclockwise direction with respect to the direction parallel to the transverse direction of the pixel region 101 is assumed to have a positive value.

As referred to above, substantially 45° means an angle in the range from 30° to 60°, or an angle in the range from 40° to 50°. As referred to above, substantially 135° means an angle in the range from 150° to 120°, or an angle in the range from 140° to 130°. As referred to above, substantially 225° means an angle in the range from 210° to 240°, or an angle in the range from 220° to 230°. As referred to above, substantially 315° means an angle in the range from 300° to 330°, or an angle in the range from 310° to 320°.

In FIG. 2, a gate line extending along the transverse direction of the pixel regions 101 is depicted at 14.

FIG. 3 is a schematic perspective view for describing the attitudes of the liquid crystal molecules 31 under an applied voltage across the liquid crystal layer 30. In FIG. 3, the first and second vertical alignment films 20 and 40 are omitted from illustration.

As for the liquid crystal molecules 31 in the first, second, third and fourth liquid crystal domains 101a 101b, 101c and 101d, the pretilt angle (tilt angle of the major axis of the liquid crystal molecule 31 with respect to the upper surface of the first glass substrate 11) in one portion is different from the pretilt angle in another.

A plurality of pixel electrodes 102 are disposed in a matrix, so as to be in rectangular-shaped regions. Each such region is a region that is delineated by a plurality of gate lines 14, 14, . . . , which are parallel to one another and a plurality of source lines 15, 15, . . . , which are parallel to one another.

The gate lines 14, 14, . . . are provided on the first glass substrate 11, and extend along a direction which is parallel to the transverse direction of the pixel regions 101. Moreover, each gate line 14 is electrically connected to gates of thin film transistors 13.

The source lines 15, 15, . . . are provided on the first glass substrate 11, and extend along a direction which is parallel to the longitudinal direction of the pixel regions 101. Moreover, each source line 15 is electrically connected to sources of thin film transistors 13.

As the thin film transistors 13, those having channels made by using silicon or an oxide semiconductor are suitably used, for example. As such an oxide semiconductor, for example, a compound composed of indium, gallium, zinc, and oxygen (In-Ga—Zn-O), a compound composed of indium, tin, zinc, and oxygen (In-Tin-Zn—O), or a compound composed of indium, aluminum, zinc, and oxygen (In—Al—Zn—O) can be used.

As the gate lines 14 and the source lines 15, those which are commonly used in the field of liquid crystal display panels can be used, e.g., a metal such as copper, titanium, chromium, aluminum, or molybdenum, or an alloy thereof, etc.

The color filter 52 is composed of red color filters 52A, green color filters 52B, and blue color filters 52C. The red color filters 52A, the green color filters 52B, and the blue color filters 52C are each located above a plurality of pixel electrodes 102 that are arranged along the longitudinal direction of the pixel regions 101, and extend along the longitudinal direction of the pixel regions 101. Note that the color filter 52 may be arranged to additionally include color filters other than the red color filters 52A, green color filters 52B, and blue color filters 52C (e.g., yellow color filters).

FIG. 4 is an enlarged plan view of a pixel electrode 102 and its neighborhood.

A drain of the thin film transistor 13 is electrically connected to a drain line 16. The drain line 16 is electrically connected also to the pixel electrode 102, via an electrical conductor in a contact hole 17.

Within each rectangular-shaped region that is delineated by the gate lines 14, 14, . . . and the source lines 15, 15, . . . , a portion of a capacitor line 18 is also formed. This portion of a capacitor line 18 is formed so as to extend along three sides of the pixel electrode 102.

The pixel electrode 102 includes: a first pixel electrode portion 102a for applying a voltage to the first and second liquid crystal domains 101a and 101b; and a second pixel electrode portion 102b for applying a voltage to the third and fourth liquid crystal domains 101c and 101d. Between the first pixel electrode portion 102a and the first and second liquid crystal domains 101a and 101b, and between the second pixel electrode portion 102b and the third and fourth liquid crystal domains 101c and 101d, the first vertical alignment film 20 exists. Between the first pixel electrode portion 102a and the second pixel electrode portion 102b, a bridging portion 102c is provided.

The first pixel electrode portion 102a includes: a first slitted region 111 that is located below the first liquid crystal domain 101a; and a second slitted region 121 that is located below the second liquid crystal domain 101b.

In the first slitted region 111, eight slits 112A, 112B, . . . , 112H extending along a direction parallel to the alignment azimuth of the liquid crystal molecules 31 in the first liquid crystal domain 101a are formed.

The slits 112A, 112B, . . . , 112H are mutually equal in width, while being set to mutually different lengths. The width of the slits 112A, 112B, . . . , 112H is set to e.g. 3.0 μm. The interval between the slits 112A, 112B, . . . , 112H is also set to e.g. 3.0 μm. In other words, the design pitch of the slits 112A, 112B, . . . , 112H may be set to e.g. 6.0 μm. Note that, in terms of facilitating fabrication the design pitch is preferably e.g. 5.2 μm or more, and in terms of improving transmittance of the pixel region 101 the design pitch is preferably e.g. 7.0 μm or less.

In the second slitted region 121, eight slits 122A, 122B, . . . , 122H extending along a direction parallel to the alignment azimuth of the liquid crystal molecules 31 in the second liquid crystal domain 101b are formed. The direction in which the slits 122A, 122B, . . . , 122H extend is orthogonal to the direction in which the slits 112A, 112B, . . . , 112H extend. Note that the direction in which the slits 122A, 122B, . . . , 122H extend may be allowed to be essentially orthogonal to the direction in which the slits 112A, 112B, . . . , 112H extend.

The slits 122A, 122B, . . . , 122H also are mutually equal in width, while being set to mutually different lengths. The width of the slits 122A, 122B, . . . , 122H is set to the same width as the width of the slits 112A, 112B, . . . , 112H. Moreover, the interval between the slits 122A, 122B, . . . , 122H is also set to the same interval as the interval between the slits 112A, 112B, . . . , 112H. Note that, in terms of facilitating fabrication the design pitch also is preferably e.g. 5.2 μm or more, and in terms of improving transmittance of the pixel 101, the design pitch of the slits 122A, 122B, . . . , 122H also is e.g. 7.0 μm or less.

Moreover, no slits are formed in the region between the slits 112A, 112B, . . . , 112H and the slits 122A, 122B, . . . , 122H.

The second pixel electrode portion 102b includes: a first slitted region 141 that is located below the third liquid crystal domain 101c; and a second slitted region 151 that is located below the fourth liquid crystal domain 101d.

In the first slitted region 141, eight slits 142A, 142B, . . . , 142H extending along a direction parallel to the alignment azimuth of the liquid crystal molecules 31 in the third liquid crystal domain 101c are formed. The direction in which the slits 142A, 142B, . . . , 142H extend is parallel to the direction in which the slits 122A, 122B, . . . , 122H extend.

The slits 142A, 142B, . . . , 142H are mutually equal in width, while being set to mutually different lengths. The width of the slits 142A, 142B, . . . , 142H is set to e.g. 3.0 μm. Moreover, the interval between the slits 142A, 142B, . . . , 142H is also set to e.g. 3.0 μm. In other words, the design pitch of the slits 142A, 142B, . . . , 142H is set to e.g. 6.0 μm. Note that, in terms of facilitating fabrication the design pitch is preferably e.g. 5.2 μm or more, and in terms of improving transmittance of the pixel region 101, the design pitch is e.g. 7.0 μm or less.

In the second slitted region 151, eight slits 152A, 152B, . . . , 152H extending along a direction parallel to the alignment azimuth of the liquid crystal molecules 31 in the fourth liquid crystal domain 101b are formed. The direction in which the slits 152A, 152B, . . . , 152H extend is orthogonal to the direction in which the slits 142A, 142B, . . . , 142H extend. Note that the direction in which the slits 152A, 152B, . . . , 152H extend may be allowed to be essentially orthogonal to the direction in which the slits 142A, 142B, . . . , 142H extend.

The slits 152A, 152B, . . . , 152H also are mutually equal in width, while being set to mutually different lengths. The width of the slits 152A, 152B, . . . , 152H is set to the same width as the width of the slits 152A, 152B, . . . , 152H. Moreover, the interval between the slits 152A, 152B, . . . , 152H is set to the same interval as the interval between the slits 142A, 142B, . . . , 142H. Note that, in terms of facilitating fabrication the design pitch of the slits 152A, 152B, . . . , 152H also is preferably e.g. 5.2 μm or more, and in terms of improving transmittance of the pixel region 101, the design pitch also is e.g. 7.0 μm or less.

Moreover, no slits are formed in the region between the slits 142A, 142B, . . . , 142H and the slits 152A, 152B, . . . , 152H.

Moreover, the distance between the slits 122A, 122B, . . . , 122H and the slits 142A, 142B, . . . , 142H is made broader than the distance between the slits 142A, 142B, . . . , 142H and the slits 152A, 152B, . . . , 152H.

The bridging portion 102c is a portion that connects between the first pixel electrode portion 102a and the second pixel electrode portion 102b. When a center line C101 which extends along the longitudinal direction of the pixel region 101 and which passes through a center of the width direction of the pixel electrode 102 is defined, the bridging portion 102c overlaps the center line C101.

Moreover, a first recess 102d is provided at one side along the width direction of the pixel electrode 102. Between the first pixel electrode portion 102a and the second pixel electrode portion 102b, the first recess 102d extends from one side along the width direction of the pixel electrode 102 toward the bridging portion 102c.

Moreover, a second recess 102e is provided at the other side along the width direction pixel electrode 102. Between the first pixel electrode portion 102a and the second pixel electrode portion 102b, the second recess 102e extends from the other side along the width direction of the pixel electrode 102 toward the bridging portion 102c.

Moreover, the first recess 102d, the bridging portion 102c, and the second recess 102e are arranged along the width direction of the pixel electrode 102. The width of the first recess 102d is set equal to the width of the second recess 102e. For example, the width of the first and second recesses 102d and 102e is set so as to fall within the range of e.g. 4.0 to 5.0 μm. To explain more specifically, one side of the first recess 102d that is closer to the first pixel electrode portion 102a is aligned in position with one side of the second recess 102e that is closer to the first pixel electrode portion 102a, along the width direction of the pixel electrode 102. In other words, one side of the first recess 102d that is closer to the first pixel electrode portion 102a is collinear with one side of the second recess 102e that is closer to the first pixel electrode portion 102a. Similarly, one side of the first recess 102d that is closer to the second pixel electrode portion 102b is collinear with one side of the second recess 102e that is closer to the second pixel electrode portion 102b.

Moreover, no slits are formed in the region between the first and second recesses 102d and 102e and the slits 122A, 122B, . . . , 122H. In other words, the first and second recesses 102d and 102e are formed in the pixel electrode 102 so as to have a predetermined interval with the slits 122A, 122B, . . . , 122H.

Moreover, no slits are formed in the region between the first and second recesses 102d and 102e and the slits 142A, 142B, . . . , 142H. In other words, the first and second recesses 102d and 102e are formed in the pixel electrode 102 so as to have a predetermined interval with the slits 142A, 142B, . . . , 142H.

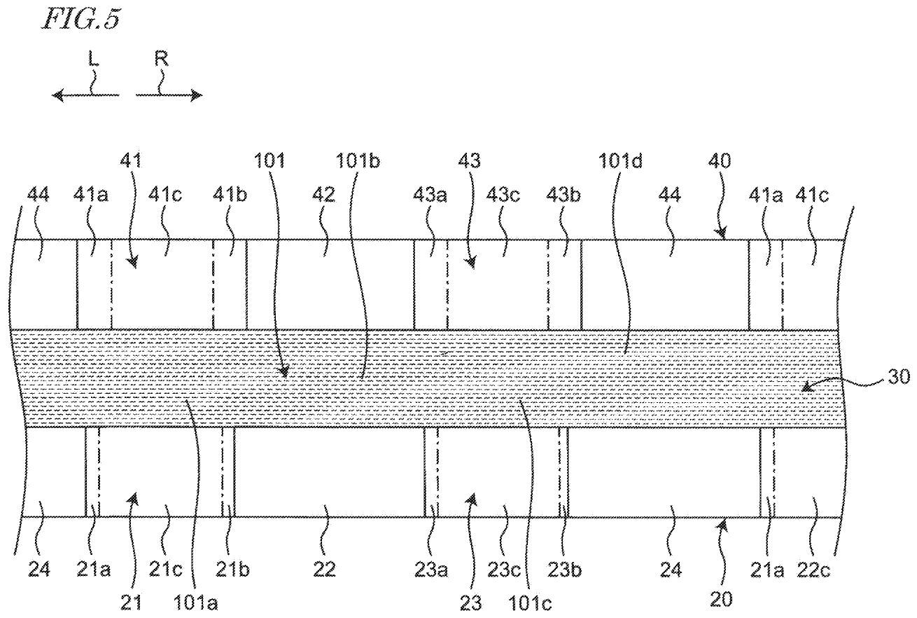

FIG. 5 is a schematic cross-sectional view of the first vertical alignment film 20, the liquid crystal layer 30, and the second vertical alignment film 40. The left-hand side in FIG. 5 corresponds to one side in a direction along the longitudinal direction of the pixel region 101. The right-hand side in FIG. 5 corresponds to the other side in the direction along the longitudinal direction of the pixel region 101.

The first vertical alignment film 20 includes a first lower alignment regulating portion 21, a second lower alignment regulating portion 22, a third lower alignment regulating portion 23, and a fourth lower alignment regulating portion 24, which regulate the alignments of the liquid crystal molecules 31 in the first liquid crystal domain 101a, the second liquid crystal domain 101b, the third liquid crystal domain 101c, and the fourth liquid crystal domain 101d from below (i.e., from the first substrate section 10 side).

The first lower alignment regulating portion 21 includes a first high-pretilt angle region 21a provided on the left-hand side in FIG. 5, a second high-pretilt angle region 21b provided on the right-hand side in FIG. 5, and a low-pretilt angle region 21c. The low-pretilt angle region 21c is provided between the first high-pretilt angle region 21a and the second high-pretilt angle region 21b. The pretilt angle in the low-pretilt angle region 21c is smaller than the pretilt angle in the first high-pretilt angle region 21a, and smaller than the pretilt angle in the second high-pretilt angle region 21b.

The second lower alignment regulating portion 22 is formed so that the pretilt angle in each is essentially uniform. The pretilt angle in each is essentially equal to the pretilt angle in the low-pretilt angle region 21c of the first lower alignment regulating portion 21. This can prevent a decrease in the alignment regulating force of the second lower alignment regulating portion 22. Note that being essentially uniform as referred to above means a level of uniformity to be attained in actual fabrication. Note that being essentially equal as referred to above means a state where no difference exists between these pretilt angles, or a state where a slight difference exists between these pretilt angles due to fluctuations associated with fabrication, for example.

The third lower alignment regulating portion 23 is formed in a similar manner to the first lower alignment regulating portion 21. More specifically, the third lower alignment regulating portion 23 includes a first high-pretilt angle region 23a provided on the left-hand side in FIG. 5, a second high-pretilt angle region 23b provided on the right-hand side in FIG. 5, and a low-pretilt angle region 23c. The low-pretilt angle region 23c is provided between the first high-pretilt angle region 23a and the second high-pretilt angle region 23b. The pretilt angle in the low-pretilt angle region 23c is smaller than the pretilt angle in the first high-pretilt angle region 23a, and smaller than the pretilt angle in the second high-pretilt angle region 23b.

Similarly to the second lower alignment regulating portion 22, the fourth lower alignment regulating portion 24 is formed so that the pretilt angle in each is essentially uniform. The pretilt angle in each is essentially equal to the pretilt angle in the low-pretilt angle region 23c of the third lower alignment regulating portion 23. This can prevent a decrease in the alignment regulating force of the fourth lower alignment regulating portion 24. Note that the pretilt angle in each of the fourth lower alignment regulating portions 24 may be essentially equal to the pretilt angle in the low-pretilt angle region 21c of the first lower alignment regulating portion 21. Note that the meanings of being essentially uniform and being essentially equal are similar to those associated with the description of the configuration of the second lower alignment regulating portion 22.

Herein, for example, the first and second high-pretilt angle regions 21a and 21b of the first lower alignment regulating portion 21 and the first and second high-pretilt angle regions 23a and 23b of the third lower alignment regulating portion 23 may be formed in such a manner as to have a pretilt angle of 89.8°. If this is to be adopted, for example, the low-pretilt angle region 21c of the first lower alignment regulating portion 21, the second lower alignment regulating portion 22, the low-pretilt angle region 23c of the third lower alignment regulating portion 23, and the fourth lower alignment regulating portion 24 may be formed in such a manner as to have a pretilt angle of 88.0°.

Moreover, the length of the first high-pretilt angle region 21a along the right-left direction in FIG. 5 may be equal to the length of the second high-pretilt angle region 21b along the right-left direction in FIG. 5.

Moreover, the length of the first high-pretilt angle region 23a along the right-left direction in FIG. 5 may be equal to the length of the second high-pretilt angle region 23b along the right-left direction in FIG. 5.

The second vertical alignment film 40 includes a first upper alignment regulating portion 41, a second upper alignment regulating portion 42, a third upper alignment regulating portion 43, and a fourth upper alignment regulating portion 44, which regulate the alignments of the liquid crystal molecules 31 in the first liquid crystal domain 101a, the second liquid crystal domain 101b, the third liquid crystal domain 101c, and the fourth liquid crystal domain 101d from above (i.e., from the second substrate section 50 side).

The first upper alignment regulating portion 41 includes a first high-pretilt angle region 41a provided on the left-hand side in FIG. 5, a second high-pretilt angle region 41b provided on the right-hand side in FIG. 5, and a low-pretilt angle region 41c. The low-pretilt angle region 41c is provided between the first high-pretilt angle region 41a and the second high-pretilt angle region 41b. The pretilt angle in the low-pretilt angle region 41c is smaller than the pretilt angle in the first high-pretilt angle region 41a, and smaller than the pretilt angle in the second high-pretilt angle region 41b.

Moreover, along the thickness direction of the second vertical alignment film 40, the first and second high-pretilt angle regions 41a and 41b of the first upper alignment regulating portion 41 are disposed so as to be partly opposed to the first and second high-pretilt angle regions 21a and 21b of the first lower alignment regulating portion 21.

Moreover, regarding length along the right-left direction in FIG. 5, the first and second high-pretilt angle regions 21a and 21b of the first lower alignment regulating portion 21 are shorter than the first and second high-pretilt angle regions 41a and 41b of the first upper alignment regulating portion 41. Herein, for example, the lengths of the first and second high-pretilt angle regions 21a and 21b along the right-left direction in FIG. 5 may be a length(s) in the range from 0 μm to 9 μm, while the lengths of the first and second high-pretilt angle regions 41a and 41b along the right-left direction in FIG. 5 may be a length(s) in the range from 14 μm to 23 μm.

Moreover, an imaginary line which passes through a midpoint between the first and second high-pretilt angle regions 41a and 41b along the right-left direction in FIG. 5 and which extends along the thickness direction of the second vertical alignment film 40 passes through a midpoint between the first and second high-pretilt angle regions 21a and 21b along the right-left direction in FIG. 5. In other words, in the thickness direction of the second vertical alignment film 40, the midpoint between the first and second high-pretilt angle regions 41a and 41b along the right-left direction in FIG. 5 is opposed to the midpoint between the first and second high-pretilt angle regions 21a and 21b along the right-left direction in FIG. 5. Alternatively, in the thickness direction of the second vertical alignment film 40, the midpoint between the first and second high-pretilt angle regions 41a and 41b along the right-left direction in FIG. 5 may not be opposed to the midpoint between the first and second high-pretilt angle regions 21a and 21b along the right-left direction in FIG. 5. If this is to be adopted, ensuring that portions of the first and second high-pretilt angle regions 41a and 41b are opposed to at least portions of first and second high-pretilt angle regions 21a and 21b in the thickness direction of the second vertical alignment film 40 would be preferable from the standpoint of suppressing an increase in the geometric area of dark lines.

The second upper alignment regulating portion 42 is formed so that the pretilt angle in each is essentially uniform. The pretilt angle in each is essentially equal to the pretilt angle in the low-pretilt angle region 41c of the first upper alignment regulating portion 41. This can prevent a decrease in the alignment regulating force of the second upper alignment regulating portion 42. Note that the meanings of being essentially uniform and being essentially equal are similar to those associated with the description of the configuration of the second lower alignment regulating portion 22.

The third upper alignment regulating portion 43 includes a first high-pretilt angle region 43a provided on the left-hand side in FIG. 5, a second high-pretilt angle region 43b provided on the right-hand side in FIG. 5, and a low-pretilt angle region 43c. The low-pretilt angle region 43c is provided between the first high-pretilt angle region 43a and the second high-pretilt angle region 43b. The pretilt angle in the low-pretilt angle region 43c is smaller than the pretilt angle in the first high-pretilt angle region 43a, and smaller than the pretilt angle in the second high-pretilt angle region 43b.

Moreover, along the thickness direction of the second vertical alignment film 40, the first and second high-pretilt angle regions 43a and 43b of the third upper alignment regulating portion 43 are disposed so as to be partly opposed to the first and second high-pretilt angle regions 23a and 23b of the third lower alignment regulating portion 23.

Moreover, regarding length along the right-left direction in FIG. 5, the first and second high-pretilt angle regions 23a and 23b of the third lower alignment regulating portion 23 are shorter than the first and second high-pretilt angle regions 43a and 43b of the third upper alignment regulating portion 43. Herein, for example, the lengths of the first and second high-pretilt angle regions 23a and 23b along the right-left direction in FIG. 5 may be a length(s) in the range from 0 μm to 9 μm, while the lengths of the first and second high-pretilt angle regions 43a and 43b along the right-left direction in FIG. 5 may be a length(s) in the range from 14 μm to 23 μm.

Moreover, an imaginary line which passes through a midpoint between the first and second high-pretilt angle regions 43a and 43b along the right-left direction in FIG. 5 and which extends along the thickness direction of the second vertical alignment film 40 passes through a midpoint between the first and second high-pretilt angle regions 23a and 23b along the right-left direction in FIG. 5. In other words, in the thickness direction of the second vertical alignment film 40, the midpoint between the first and second high-pretilt angle regions 43a and 43b along the right-left direction in FIG. 5 is opposed to the midpoint between the first and second high-pretilt angle regions 23a and 23b along the right-left direction in FIG. 5. Alternatively, in the thickness direction of the second vertical alignment film 40, the midpoint between the first and second high-pretilt angle regions 43a and 43b along the right-left direction in FIG. 5 may not be opposed to the midpoint between the first and second high-pretilt angle regions 23a and 23b along the right-left direction in FIG. 5. If this is to be adopted, ensuring that portions of the first and second high-pretilt angle regions 43a and 43b are opposed to at least portions of first and second high-pretilt angle regions 23a and 23b in the thickness direction of the second vertical alignment film 40 would be preferable from the standpoint of suppressing an increase in the geometric area of dark lines.

Similarly to the second upper alignment regulating portion 42, the fourth upper alignment regulating portion 44 is formed so that the pretilt angle in each is essentially uniform. The pretilt angle in each is essentially equal to the pretilt angle in the low-pretilt angle region 43c of the third upper alignment regulating portion 43. This can prevent a decrease in the alignment regulating force of the fourth upper alignment regulating portion 44. Note that the pretilt angle in each of the fourth upper alignment regulating portions 44 may be essentially equal to the pretilt angle in the low-pretilt angle region 41c of the first upper alignment regulating portion 41. Note that the meanings of being essentially uniform and being essentially equal are similar to those associated with the description of the configuration of the second lower alignment regulating portion 22.

Herein, for example, the first and second high-pretilt angle regions 41a and 41b of the first upper alignment regulating portion 41 and the first and second high-pretilt angle regions 43a and 43b of the third upper alignment regulating portion 43 may be formed in such a manner as to have a pretilt angle of 89.8°. If this is to be adopted, for example, the low-pretilt angle region 41c of the first upper alignment regulating portion 41, the second upper alignment regulating portion 42, the low-pretilt angle region 43c of the third upper alignment regulating portion 43, and the fourth upper alignment regulating portion 44 may be formed in such a manner as to have a pretilt angle of 88.0°.

Moreover, the length of the first high-pretilt angle region 41a along the right-left direction in FIG. 5 may be equal to the length of the second high-pretilt angle region 41b along the right-left direction in FIG. 5.

Moreover, the length of the first high-pretilt angle region 43a along the right-left direction in FIG. 5 may be equal to the length of the second high-pretilt angle region 43b along the right-left direction in FIG. 5.

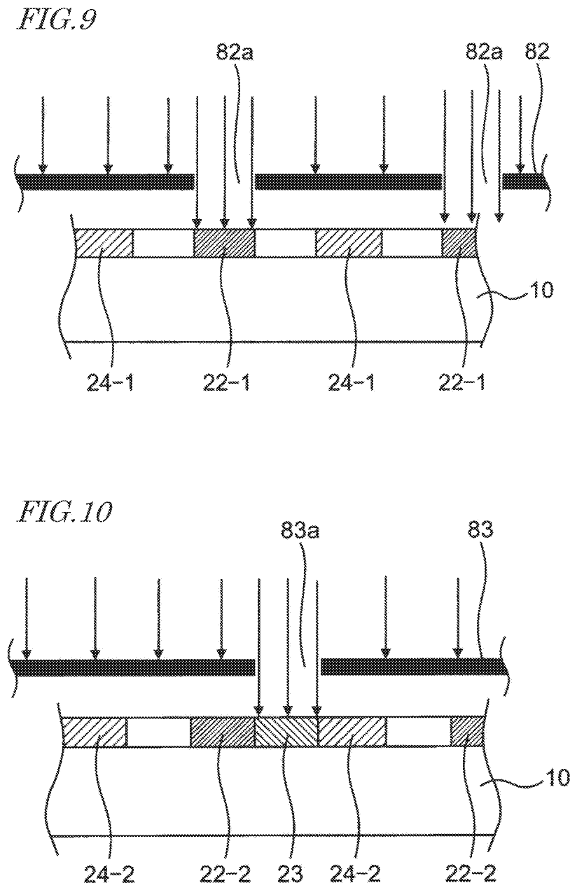

Hereinafter, a production method for the liquid crystal display panel above will be described. Note that arrows in FIG. 8 to FIG. 11 represent directions in which light travels during light irradiation, and also indicate regions through which light passes during light irradiation.

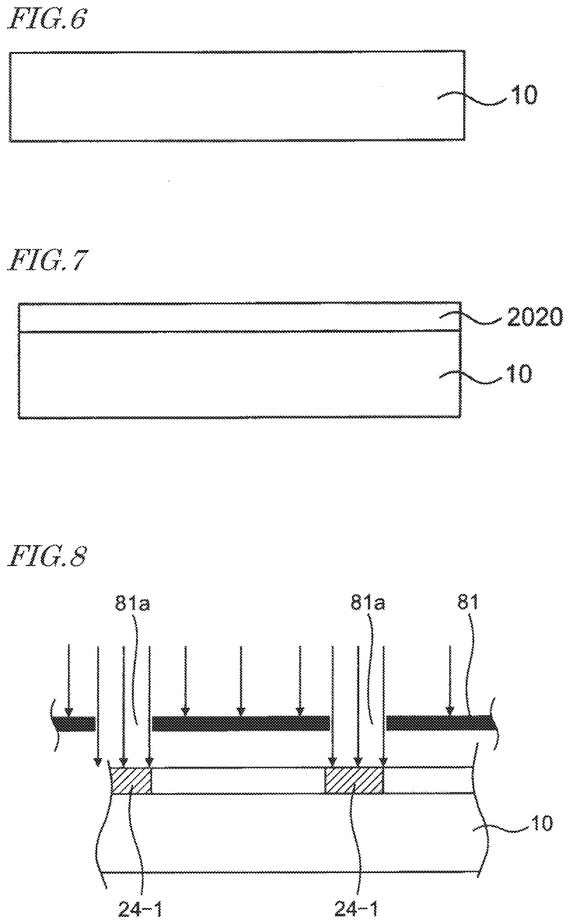

First, as shown in FIG. 6 and FIG. 7, after a first substrate section 10 is formed, a material film 2020 to become the material of a first vertical alignment film 20 is formed on the first substrate section 10.

Next, light irradiation is performed for the first substrate section 10 from above. At this time, as shown in FIG. 8, a fourth lower alignment regulating portion 24-1 is formed under each aperture 81a by using a mask 81 having a plurality of apertures 81a, 81a, . . . , 81a (only two of which are shown in FIG. 8). The alignment direction in the respective fourth lower alignment regulating portion 24-1 coincides with the alignment direction in the fourth lower alignment regulating portion 24. Note that each aperture 81a is an aperture extending along the transverse direction of the pixel region 101.

Next, as shown in FIG. 9, light irradiation is performed by using a mask 82 having a plurality of apertures 82a, 82a, . . . , 82a (only two of which are shown in FIG. 9) at positions different from those of the apertures 81a in the mask 81. Although this light irradiation is performed for the first substrate section 10 from above as in the case of FIG. 8, it is performed in a direction that is different from the direction of the light irradiation performed through the apertures 81a in the mask 81. Stated otherwise, in a plan view, the direction of light travel during the light irradiation in FIG. 9 differs from the direction of light travel during the light irradiation in FIG. 8. As a result of this, second lower alignment regulating portions 22-1 are formed between the fourth lower alignment regulating portions 24-1. The alignment direction in the respective second lower alignment regulating portion 22-1 coincides with the alignment direction in the second lower alignment regulating portion 22. Note that each aperture 82a also is an aperture extending along the transverse direction of the pixel region 101.

Next, as shown in FIG. 10, light irradiation is performed by using a mask 83 having a plurality of apertures 83a, 83a, . . . , 83a (only one of which is shown in FIG. 10). The aperture positions in the mask 83 are different from the aperture positions in the masks 81 and 82. Although this light irradiation is performed for the first substrate section 10 from above as in the case of FIG. 8 and FIG. 9, it is performed in a direction that is different from the direction of the light irradiation performed through the respective apertures 81a and 82a in the masks 81 and 82.

Moreover, portions of the light having passed through each aperture 83a in the mask 83 are radiated at the right end of the second lower alignment regulating portion 22-1 in FIG. 9 and the left end of the fourth lower alignment regulating portion 24-1 in FIG. 9. These ends become portions that have been exposed to light twice, i.e., so-called double-exposed portions, to constitute subportions of the third lower alignment regulating portion 23. At this time, the third lower alignment regulating portion 23 is interposed between the second lower alignment regulating portion 22-2 and the fourth lower alignment regulating portion 24-2. Note that each aperture 83a also is an aperture extending along the transverse direction of the pixel region 101.

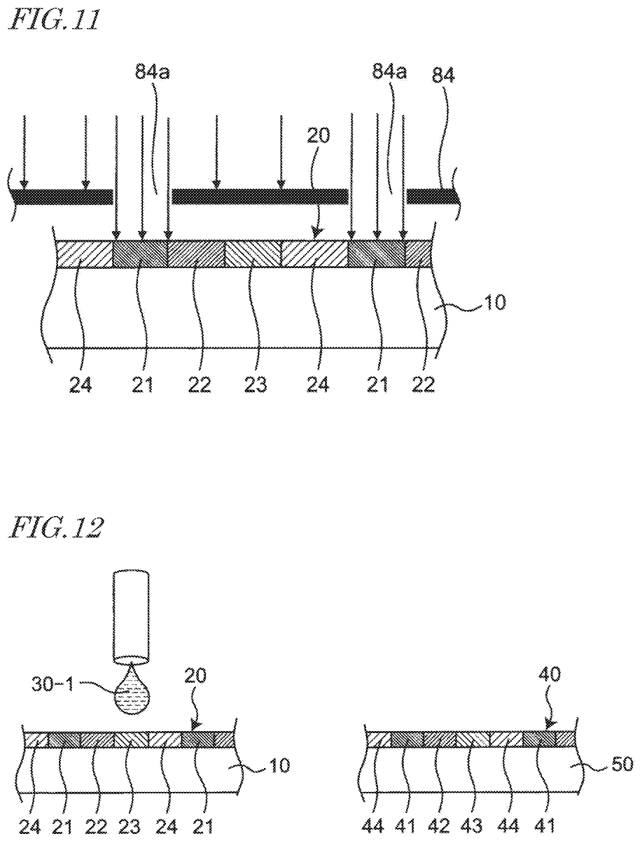

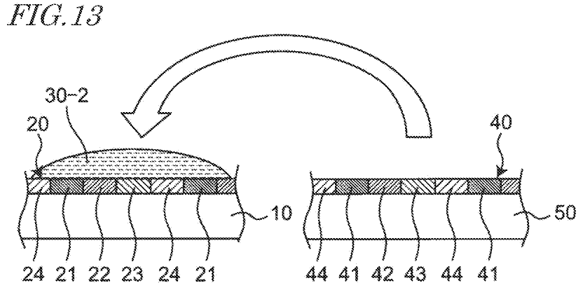

Next, as shown in FIG. 11, light irradiation is performed by using a mask 84 having different aperture positions from those in the masks 81 to 83. Although this light irradiation is performed for the first substrate section 10 from above as in the case of FIG. 8 to FIG. 10, it is performed in a direction that is different from the direction of the light irradiation performed through the respective apertures 81a, 82a and 83a in the masks 81, 82 and 83. At this time, light passes through a plurality of apertures 84a, 84a, . . . , 84a (only two of which are shown in FIG. 11) formed in the mask 84. Moreover, portions of the light having passed through each aperture 84a in the mask 84 are radiated at the left end of the second lower alignment regulating portion 22-2 in FIG. 10 and the right end of the fourth lower alignment regulating portion 24-2 in FIG. 10. These ends become so-called double-exposed portions, to be included in the first lower alignment regulating portion 21. Thus, when the first lower alignment regulating portion 21 is formed, the first vertical alignment film 20 is obtained upon the first substrate section 10. Note that each aperture 84a also is an aperture extending along the transverse direction of the pixel region 101.

Next, after forming a material film to become the material of the second vertical alignment film 40 on the second substrate section 50, irradiations similar to those in FIG. 8 to FIG. 11 are performed to form the second vertical alignment film 40 as shown in FIG. 5 on the second substrate section 50. At this time, light irradiation is performed in such a manner that the length of any double-exposed region in the material film (i.e., length along a direction corresponding to the directions of arrows L and R in FIG. 5) is longer than the length of any double-exposed region in the material film 2020 to become the material of the first vertical alignment film 20 (i.e., length along a direction corresponding to the directions of arrows L and R in FIG. 5).

Next, a sealing member 90 (shown in FIG. 1) is formed on the periphery of the second substrate section 50. On the other hand, as shown in FIG. 12, liquid crystal material 30-1 is dropped onto the first substrate section 10 from above the first substrate section 10. Consequently, as shown in FIG. 13, a liquid crystal layer 30-2 is formed on the first vertical alignment film 20.

Next, the second substrate section 50, which is turned upside down, is placed on the liquid crystal layer 30-2. As a result, the sealing member 90 is disposed around the liquid crystal layer 30-2.

Finally, a first polarizer 60 is disposed under the first substrate section 10, and a second polarizer 70 is disposed under the second substrate section 50.

In such a production method, light irradiation is performed in such a manner that the length of any double-exposed region in the first vertical alignment film 20 is shorter than the length of any double-exposed region in the second vertical alignment film 40. The double-exposed regions in the first lower alignment regulating portion 21 are the first and second high-pretilt angle regions 21a and 21b, whereas the double-exposed regions in the first upper alignment regulating portion 41 are the first and second high-pretilt angle regions 41a and 41b. Therefore, the first and second high-pretilt angle regions 21a and 21b of the first lower alignment regulating portion 21 are shorter in length, in a direction along the longitudinal direction of the pixel region 101, than the first and second high-pretilt angle regions 41a and 41b of the first upper alignment regulating portion 41. As a result, even if the second vertical alignment film 40 is deviated from an intended position due to a manufacturing error, for example, there is higher likelihood that at least portions of the first and second high-pretilt angle regions 21a and 21b of the first lower alignment regulating portion 21 will be opposed to the first and second high-pretilt angle regions 41a and 41b of the first upper alignment regulating portion 41, along the thickness direction of the first and second vertical alignment films 20 and 40.

Moreover, the double-exposed regions in the third lower alignment regulating portion 23 are the first and second high-pretilt angle regions 23a and 23b, whereas the double-exposed regions in the third upper alignment regulating portion 43 are the first and second high-pretilt angle regions 43a and 43b. Therefore, the first and second high-pretilt angle regions 23a and 23b of the third lower alignment regulating portion 23 also are shorter in length, in a direction along the longitudinal direction of the pixel region 101, than the first and second high-pretilt angle regions 43a and 43b of the third upper alignment regulating portion 43. As a result, even if the second vertical alignment film 40 is deviated from an intended position due to a manufacturing error, for example, there is higher likelihood that at least portions of the first and second high-pretilt angle regions 23a and 23b of the third lower alignment regulating portion 23 will be opposed to the first and second high-pretilt angle regions 43a and 43b of the third upper alignment regulating portion 43, along the thickness direction of the first and second vertical alignment films 20 and 40.

Thus, when light is transmitted through the pixel region 101, an increase in the geometric area of dark lines to be observed from above the first, second, third and fourth liquid crystal domains 101a 101b, 101c and 101d can be suppressed.

Moreover, the pixel electrode 102 includes openings such as a slit 112A. An electric field at the edge of such an opening strongly regulates the liquid crystal molecules 31. Therefore, when the first substrate section 10 and the second substrate section 50 are attached together, even if a deviation in position between the high-pretilt angle regions in the first and the third lower alignment regulating portions 21 and 23 occurs, the alignment of the liquid crystal molecules 31 can still be strongly regulated with the aforementioned electric field. As a result, an increase in the geometric area of dark lines to be observed from above the first, second, third and fourth liquid crystal domains 101a 101b, 101c and 101d can be effectively suppressed.

Moreover, the first high-pretilt angle regions 21a, 23a, 41a and 43a and the second high-pretilt angle regions 21b, 23b, 41b and 43b are each formed through two instances of exposure with mutually different light irradiation directions. This can prevent unexposed regions from being formed in the first and second vertical alignment films 20 and 40.

In the first embodiment, such slits as are formed in the pixel electrode 102 are not formed in the counter electrode 103; however, they may be formed in the counter electrode 103. If this is to be adopted, slits may not be formed in the pixel electrode 102, and the second vertical alignment film 40 may be disposed between the first substrate section 10 and the liquid crystal layer 30, while the first vertical alignment film 20 may be disposed between the second substrate section 50 and the liquid crystal layer 30.

In the first embodiment, the first high-pretilt angle regions 21a, 23a, 41a and 43a and the second high-pretilt angle regions 21b, 23b, 41b and 43b were so-called double-exposed regions; however, they may be unexposed regions.

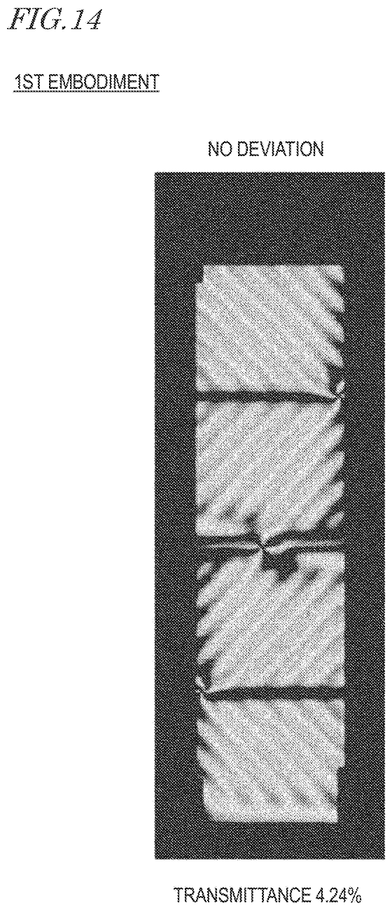

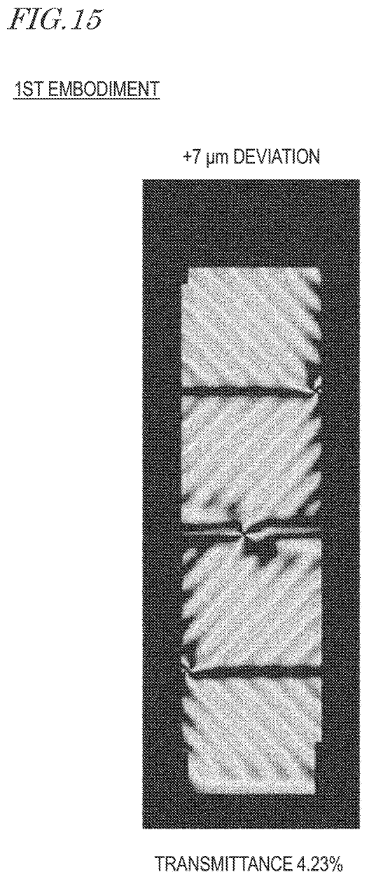

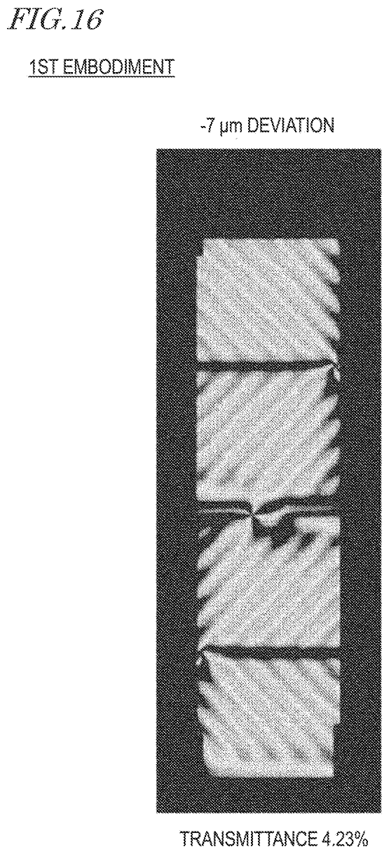

FIG. 14 is a photographic representation of one pixel, showing a simulation result of dark lines occurring above the first, second, third and fourth liquid crystal domains 101a 101b, 101c and 101d, in the case where the relative positioning between the periphery of the first vertical alignment film 20 and the second vertical alignment film 40 is as shown in FIG. 5. In FIG. 14, “no deviation” means the second vertical alignment film 40 being in the state shown in FIG. 5.

In the first embodiment above, the sealing member 90 is formed on the periphery of the second substrate section 50, and the liquid crystal material 30-1 is dropped onto the first substrate section 10; however, the sealing member 90 may be formed on the periphery of the first substrate section 10, and the liquid crystal material 30-1 may be dropped onto the second substrate section 50. Alternatively, the sealing member 90 may be formed on the periphery of the first substrate section 10, and the liquid crystal material 30-1 may be dropped onto the first substrate section 10; or, the sealing member 90 may be formed on the periphery of the second substrate section 50, and the liquid crystal material 30-1 may be dropped onto the second substrate section 50.

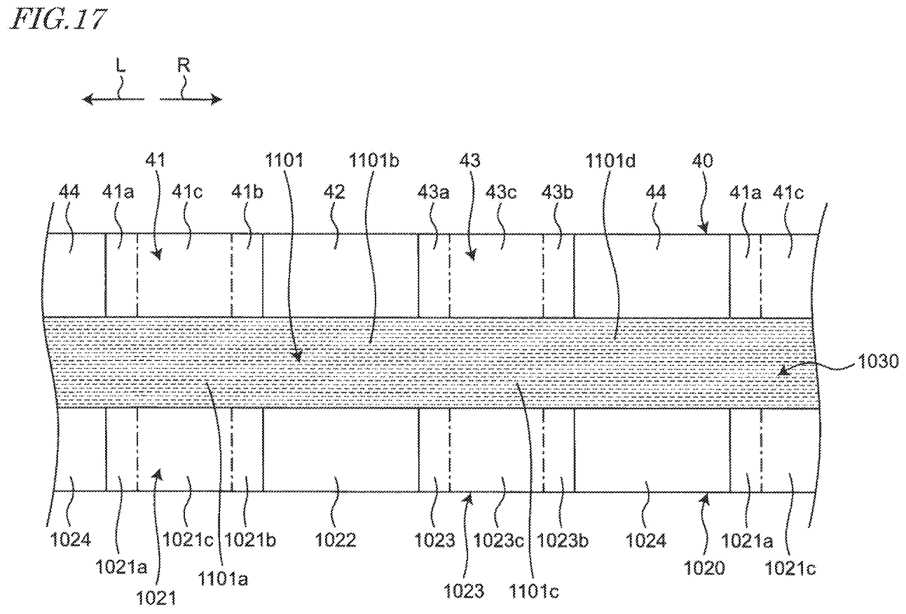

FIG. 15 is a photographic representation of one pixel, showing a simulation result of dark lines as observed from above the first, second, third and fourth liquid crystal domains 101a 101b, 101c and 101d, in the case where the second vertical alignment film 40 is shifted by 7 μm in the direction of arrow L from the state of FIG. 5. In FIG. 15, “+7 μm deviation” means the second vertical alignment film 40 being shifted by 7 μm in the direction of arrow L from the state shown in FIG. 5.

FIG. 16 is a photographic representation of one pixel, showing a simulation result of dark lines as observed from above the first, second, third and fourth liquid crystal domains 101a 101b, 101c and 101d, in the case where the second vertical alignment film 40 is shifted by 7 μm in the direction of arrow R from the state of FIG. 5. In FIG. 16, “−7 μm deviation” means the second vertical alignment film 40 being shifted by 7 μm in the direction of arrow R from the state shown in FIG. 5.

As shown in FIG. 5, and FIG. 14 to FIG. 16, even if the second vertical alignment film 40 is shifted by 7 μm in the direction of arrow L or shifted by 7 μm in the direction of arrow R from the state of FIG. 5, transmittance is decreased only by 0.01%.

In the simulations from FIG. 14 to FIG. 16, the lengths of the first high-pretilt angle regions 21a and 23a along the right-left direction in FIG. 5 and the lengths of the second high-pretilt angle regions 21b and 23b along the right-left direction in FIG. 5 are set to 3 μm, whereas the lengths of the first high-pretilt angle regions 41a and 43a along the right-left direction in FIG. 5 and the lengths of the second high-pretilt angle regions 41b and 43b along the right-left direction in FIG. 5 are set to 14 μm.

FIG. 17 is a diagram schematically showing a cross section of a liquid crystal layer 1030 and its neighborhood, in a liquid crystal display panel according to a first comparative example.

The liquid crystal display panel according to the first comparative example is identical in configuration to the liquid crystal display panel according to the first embodiment, except for including a first vertical alignment film 1020 which is different from the first vertical alignment film 20 and a liquid crystal layer 1030 having a different alignment state from that of the liquid crystal layer 30.

Similarly to the liquid crystal display panel according to the first embodiment, in the liquid crystal display panel according to the first comparative example, too, a plurality of rectangular-shaped pixel regions 1101 are arranged in a matrix. Each pixel region 1101 includes four first, second, third and fourth liquid crystal domains 1101a, 1101b, 1101c and 1101d, which differ from one another in terms of the alignment azimuth of the liquid crystal molecules. The liquid crystal domains 1101a, 1101b, 1101c and 1101d are arranged along the longitudinal direction of the pixel region 1101 (i.e., the right-left direction in FIG. 17). Moreover, the alignment azimuths of the liquid crystal molecules in the first, second, third and fourth liquid crystal domains 1101a, 1101b, 1101c and 1101d are identical to the alignment azimuths of the liquid crystal molecules in the first, second, third and fourth liquid crystal domains 101a 101b, 101c and 101d. Note that the pixel region 1101 is a region of the liquid crystal display panel according to the first comparative example corresponding to one pixel in terms of displaying.

The first vertical alignment film 1020 includes a first lower alignment regulating portion 1021, a second lower alignment regulating portion 1022, a third lower alignment regulating portion 1023, and a fourth lower alignment regulating portion 1024, which regulate the alignments of the liquid crystal molecules in the first liquid crystal domain 1101a, the second liquid crystal domain 1101b, the third liquid crystal domain 1101c, and the fourth liquid crystal domain 1101d from below.

The first lower alignment regulating portion 1021 differs from the first lower alignment regulating portion 21 with respect to the respective lengths of the first and second high-pretilt angle regions 1021a and 1021b and the low-pretilt angle region 1021c along the right-left direction in FIG. 17.

The second lower alignment regulating portion 1022 differs from the second lower alignment regulating portion 22 only with respect to its length along the right-left direction in FIG. 17. Stated otherwise, by altering the length of the second lower alignment regulating portion 22 along the right-left direction in FIG. 5, the second lower alignment regulating portion 1022 is obtained.

The third lower alignment regulating portion 1023 differs from the third lower alignment regulating portion 23 with respect to the respective lengths of the first and second high-pretilt angle region 1023a and 1023b and the low-pretilt angle region 1023c along the right-left direction in FIG. 17.

The fourth lower alignment regulating portion 1024 differs from the fourth lower alignment regulating portion 24 only with respect to its length along the right-left direction in FIG. 17. Stated otherwise, by altering the length of the fourth lower alignment regulating portion 24 along the right-left direction in FIG. 5, the fourth lower alignment regulating portion 1024 is obtained.

Moreover, along the thickness direction of the first vertical alignment film 1020, the first and second high-pretilt angle regions 41a and 41b of the first upper alignment regulating portion 41 are disposed so that they are entirely opposed to the first and second high-pretilt angle regions 1021a and 1021b of the first lower alignment regulating portion 1021.

Moreover, along the thickness direction of the first vertical alignment film 1020, the first and second high-pretilt angle regions 43a and 43b of the third upper alignment regulating portion 43 also are disposed so that they are entirely opposed to the first and second high-pretilt angle region 1023a and 1023b of the first lower alignment regulating portion 1023.

Moreover, regarding length along the right-left direction in FIG. 17, the first and second high-pretilt angle regions 41a and 41b of the first upper alignment regulating portion 41 are equal to the first and second high-pretilt angle regions 1021a and 1021b of the first lower alignment regulating portion 1021.

Moreover, regarding length along the right-left direction in FIG. 17, the first and second high-pretilt angle regions 43a and 43b of the third upper alignment regulating portion 43 are equal to the first and second high-pretilt angle region 1023a and 1023b of the first lower alignment regulating portion 1023.

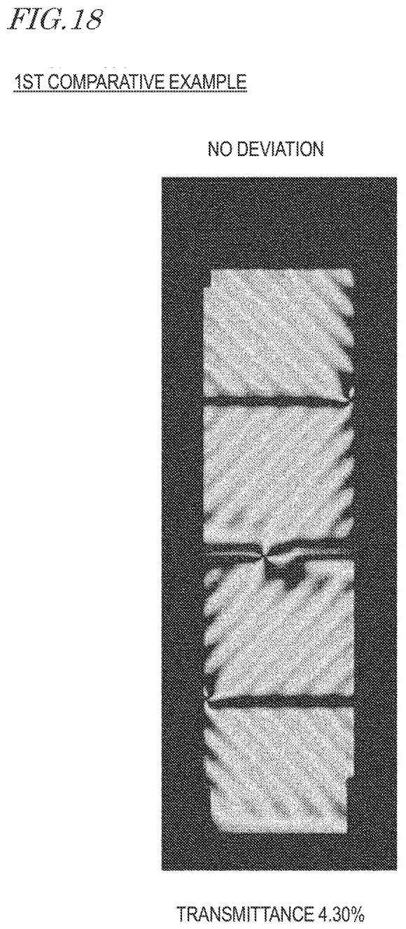

FIG. 18 is a photographic representation of one pixel, showing a simulation result of dark lines occurring above the first, second, third and fourth liquid crystal domains 1101a, 1101b, 1101c and 1101d, in the case where the relative positioning between the periphery of the first vertical alignment film 1020 and the second vertical alignment film 40 is as shown in FIG. 17. In FIG. 18, “no deviation” means the second vertical alignment film 40 being in the state shown FIG. 17.

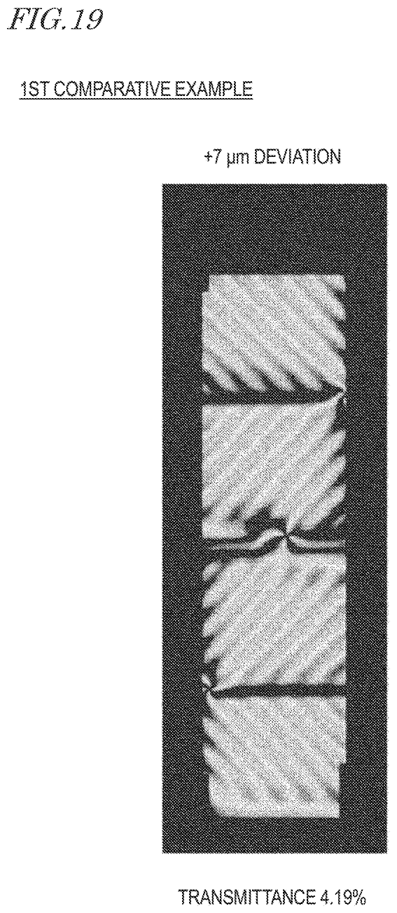

FIG. 19 is a photographic representation of one pixel, showing a simulation result of dark lines as observed from above the first, second, third and fourth liquid crystal domains 1101a, 1101b, 1101c and 1101d, in the case where the second vertical alignment film 40 is shifted by 7 μm in the direction of arrow L from the state of FIG. 17. In FIG. 19, “+7 μm deviation” means the second vertical alignment film 40 being shifted by 7 μm in the direction of arrow L from the state shown in FIG. 17.

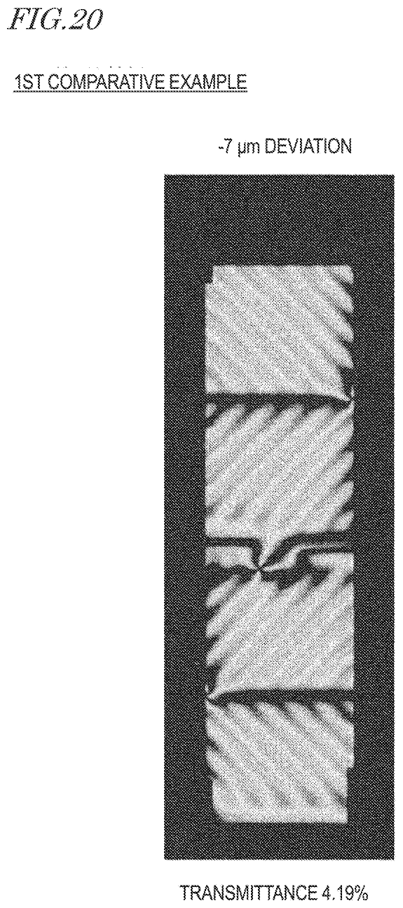

FIG. 20 is a photographic representation of one pixel, showing a simulation result of dark lines as observed from above the first, second, third and fourth liquid crystal domains 1101a, 1101b, 1101c and 1101d, in the case where the second vertical alignment film 40 is shifted by 7 μm in the direction of arrow R from the state of FIG. 17. In FIG. 20, “−7 μm deviation” means the second vertical alignment film 40 being shifted by 7 μm in the direction of arrow R from the state shown in FIG. 17.

As is clear from a comparison between FIG. 14 to FIG. 16 and FIG. 18 to FIG. 20, when the second vertical alignment film 40 fails to be disposed at the intended position, the dark lines have a larger geometric area in the liquid crystal display panel according to the first comparative example than in the liquid crystal display panel according to the first embodiment. More specifically, as shown in FIG. 17 to FIG. 20, if the second vertical alignment film 40 is shifted by 7 μm in the direction of arrow L or shifted by 7 μm in the direction of arrow R from the state of FIG. 17, the transmittance is decreased by as much as 0.11%. Therefore, the decrease in the transmittance of the liquid crystal display panel according to the first comparative example is 11 times as large as the decrease in the transmittance of the liquid crystal display panel according to the first embodiment.

Note that, in the simulations from FIG. 14 to FIG. 16, the lengths of the first high-pretilt angle region 41a, 43a, 1021a and 1023a and the second high-pretilt angle regions 41b, 43b, 1021b and 1023b along the right-left direction in FIG. 5 are set to 3 μm.

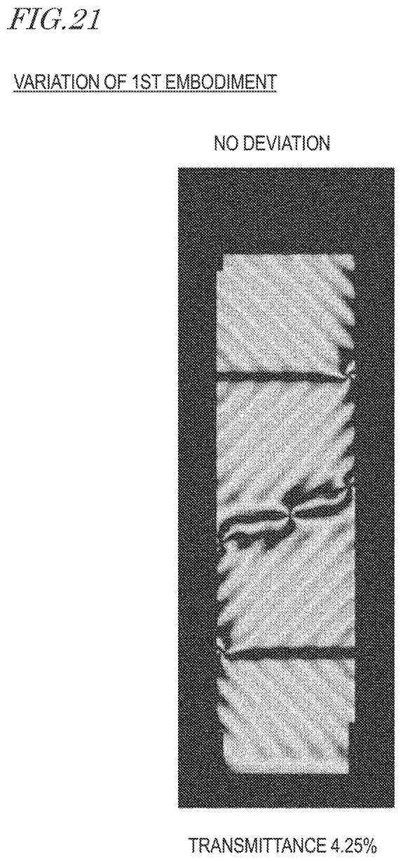

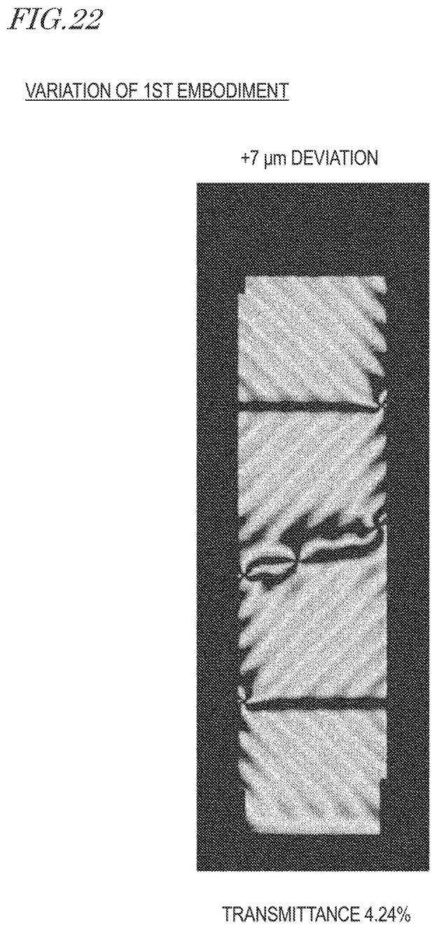

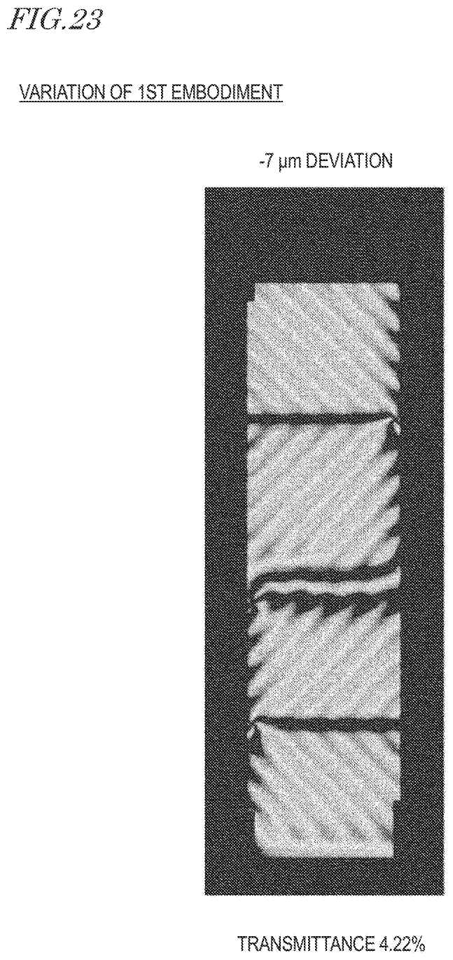

In the first embodiment, the pixel electrode 102 includes the first and second recesses 102d and 102e; however, the first and second recesses 102d and 102e may not be included. If this is adopted, a photographic representation of one pixel, showing a simulation result of dark lines, will be as shown in FIG. 21 to FIG. 23.

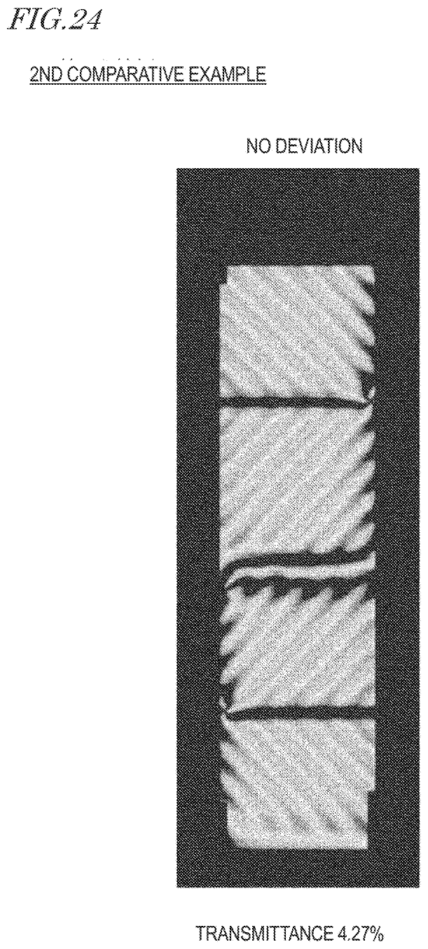

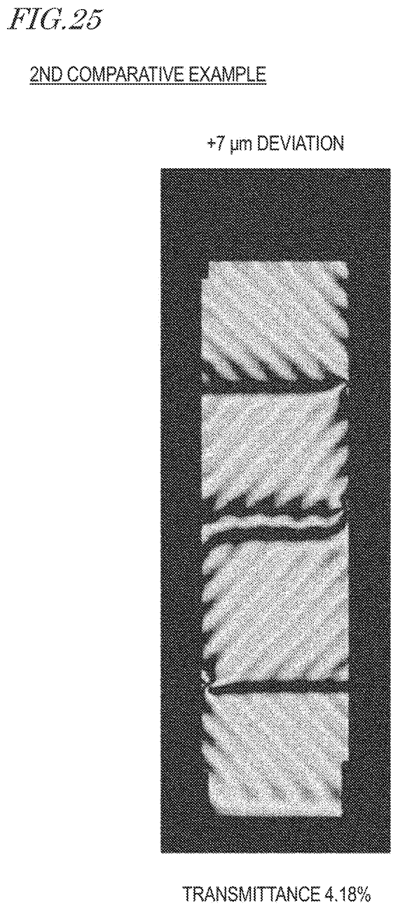

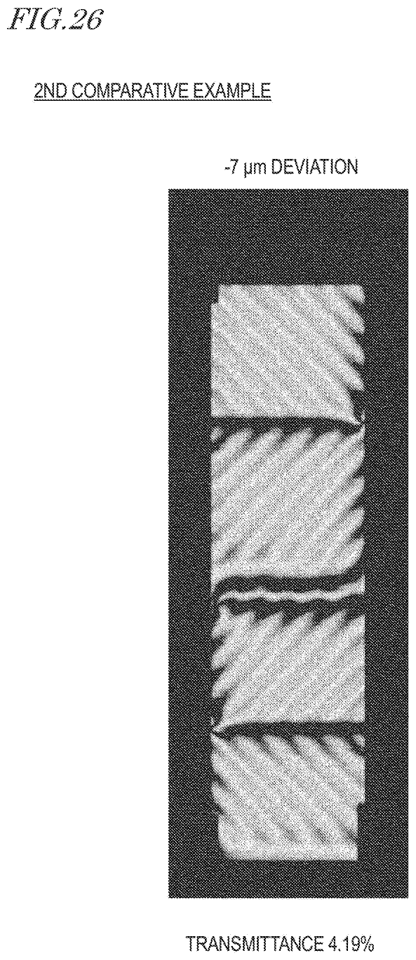

On the other hand, the first and second recesses 102d and 102e may be eliminated from the aforementioned pixel electrode 102 and the first vertical alignment film 1020 may be used instead of the first vertical alignment film 20, this being referred to as a liquid crystal display panel according to a second comparative example. A photographic representation of one pixel of this second comparative example, showing a simulation result of dark lines, will be as shown in FIG. 24 to FIG. 26.

As is clear from a comparison between FIG. 21 to FIG. 23 and FIG. 24 to FIG. 26, when a deviation in position occurs in the second vertical alignment film 40, the decrease in transmittance is much smaller in the aforementioned variation of the first embodiment. Conversely stated, the liquid crystal display panel according to the second comparative example has much larger fluctuations in transmittance than that in the aforementioned variation of the first embodiment.

### Second Embodiment

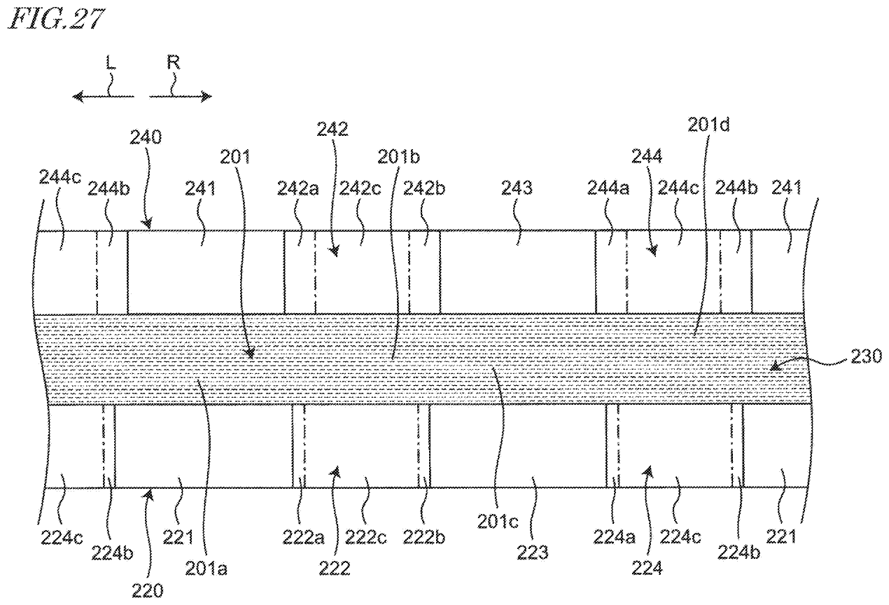

FIG. 27 is a diagram schematically showing a cross section of a liquid crystal layer 1030 and its neighborhood, in a liquid crystal display panel according to a second embodiment of this invention. The left-hand side in FIG. 27 corresponds to one side in a direction along the longitudinal direction of the pixel region 201. The right-hand side in FIG. 27 corresponds to the other side in the direction along the longitudinal direction of the pixel region 201.

The liquid crystal display panel according to the second embodiment is identical in configuration to the liquid crystal display panel according to the first embodiment, except for including first and second vertical alignment films 220 and 240 which are different from the first and second vertical alignment films 20 and 40.

Moreover, similarly to the liquid crystal display panel according to the first embodiment, in the liquid crystal display panel according to the first comparative example, too, a plurality of rectangular-shaped pixel regions 201 are arranged in a matrix. Each pixel region 201 includes four first, second, third and fourth liquid crystal domains 201a, 201b, 201c and 201d, which differ from one another in terms of the alignment azimuth of the liquid crystal molecule. The first, second, third and fourth liquid crystal domains 201a, 201b, 201c and 201d are arranged along the longitudinal direction of the pixel region 201 (i.e., the right-left direction in FIG. 27). Moreover, the alignment azimuths of the liquid crystal molecules in the first, second, third and fourth liquid crystal domains 201a, 201b, 201c and 201d are identical to the alignment azimuths of the liquid crystal molecules in the first, second, third and fourth liquid crystal domains 101a 101b, 101c and 101d. Note that the pixel region 201 is a region of the liquid crystal display panel according to the second embodiment corresponding to one pixel in terms of displaying.

The first vertical alignment film 220 includes a first lower alignment regulating portion 221, a second lower alignment regulating portion 222, a third lower alignment regulating portion 223, and a fourth lower alignment regulating portion 224, which regulate the alignments of the liquid crystal molecules in the first liquid crystal domain 201a, the second liquid crystal domain 201b, the third liquid crystal domain 201c, and the fourth liquid crystal domain 201d from below.

The first and third lower alignment regulating portions 221 and 223 lack double-exposed portions such as the first and second high-pretilt angle regions 21a, 23a, 21b and 23b in the first embodiment. The respective first lower alignment regulating portion 221 is identical in configuration to the low-pretilt angle region 21c in the first embodiment. On the other hand, the respective third lower alignment regulating portion 223 is identical in configuration to the low-pretilt angle region 23c in the first embodiment. In other words, the first and third lower alignment regulating portions 221 and 223 are formed so that the pretilt angle in each is essentially uniform.

On the other hand, the second and fourth lower alignment regulating portions 222 and 224 includes double-exposed portions such as the first and second high-pretilt angle regions 21a, 23a, 21b and 23b in the first embodiment.

The second lower alignment regulating portion 222 includes a low-pretilt angle region 222c. The low-pretilt angle region 222c is formed so that its pretilt angle and the like are identical to those of the second lower alignment regulating portion 22 in the first embodiment. Moreover, the second lower alignment regulating portion 222 includes first and second high-pretilt angle regions 222a and 222b, between which the low-pretilt angle region 222c is interposed. The respective pretilt angles in the first and second high-pretilt angle regions 222a and 222b are larger than the pretilt angle in the low-pretilt angle region 222c.

The fourth lower alignment regulating portion 224 includes a low-pretilt angle region 224c. The low-pretilt angle region 224c is formed so that its pretilt angle and the like are identical to those of the fourth lower alignment regulating portion 24 in the first embodiment. Moreover, the fourth lower alignment regulating portion 224 includes first and second high-pretilt angle regions 224a and 224b, between which the low-pretilt angle region 224c is interposed. The respective pretilt angles in the first and second high-pretilt angle regions 224a and 224b are larger than the pretilt angle in the low-pretilt angle region 224c.

Herein, for example, the first and second high-pretilt angle regions 222a and 222b of the second lower alignment regulating portion 222 and the first and second high-pretilt angle regions 224a and 224b of the fourth lower alignment regulating portion 224 may be formed in such a manner as to have a pretilt angle of 89.8°. If this is to be adopted, for example, the first lower alignment regulating portion 221, the low-pretilt angle region 222c of the second lower alignment regulating portion 222, the third lower alignment regulating portion 223, and the low-pretilt angle region 224c of the fourth lower alignment regulating portion 224 may be formed in such a manner as to have a pretilt angle of 88.0°.

Moreover, the length of the first high-pretilt angle region 222a along the right-left direction in FIG. 27 may be equal to the length of the second high-pretilt angle region 222b along the right-left direction in FIG. 27.

Moreover, the length of the first high-pretilt angle region 224a along the right-left direction in FIG. 27 may be equal to the length of the second high-pretilt angle region 224b along the right-left direction in FIG. 27.

The second vertical alignment film 240 includes a first upper alignment regulating portion 241, a second upper alignment regulating portion 242, a third upper alignment regulating portion 243, and a fourth upper alignment regulating portion 244, which regulate the alignments of the liquid crystal molecules in the first liquid crystal domain 201a, the second liquid crystal domain 201b, the third liquid crystal domain 201c, and the fourth liquid crystal domain 201d from above.

The first and third upper alignment regulating portions 241 and 243 lack double-exposed portions such as the first and second high-pretilt angle regions 41a, 43a, 41b and 43b in the first embodiment. The respective first upper alignment regulating portion 241 is identical in configuration to the low-pretilt angle region 41c in the first embodiment. On the other hand, the respective third upper alignment regulating portion 243 is identical in configuration to the low-pretilt angle region 43c in the first embodiment. In other words, the first and third upper alignment regulating portions 241 and 243 are formed so that the pretilt angle in each is essentially uniform.

On the other hand, the second and fourth upper alignment regulating portions 242 and 244 include double-exposed portions such as the first and second high-pretilt angle regions 41a, 41b, 43a, and 43b in the first embodiment.

The second upper alignment regulating portion 242 includes a low-pretilt angle region 242c. The low-pretilt angle region 242c is formed so that its pretilt angle and the like are identical to those of the second upper alignment regulating portion 42 in the first embodiment. Moreover, the second upper alignment regulating portion 242 includes first and second high-pretilt angle regions 242a and 242b, between which the low-pretilt angle region 242c is interposed. The respective pretilt angles in the first and second high-pretilt angle regions 242a and 242b are larger than the pretilt angle in the low-pretilt angle region 242c.

Moreover, along the thickness direction of the second vertical alignment film 240, the first and second high-pretilt angle regions 242a and 242b of the second upper alignment regulating portion 242 are disposed so as to be partly opposed to the first and second high-pretilt angle regions 222a and 222b of the second lower alignment regulating portion 222.

Moreover, the first and second vertical alignment films 220 and 240 are formed so that, regarding length along the right-left direction in FIG. 27, the first and second high-pretilt angle regions 222a and 222b of the second lower alignment regulating portion 222 are shorter than the first and second high-pretilt angle regions 242a and 242b of the second upper alignment regulating portion 242. Herein, for example, the lengths of the first and second high-pretilt angle regions 222a and 222b along the right-left direction in FIG. 27 may be a length(s) in the range from 0 μm to 9 μm, while the lengths of the first and second high-pretilt angle regions 242a and 242b along the right-left direction in FIG. 27 may be a length(s) in the range from 14 μm to 23 μm.

Moreover, an imaginary line which passes through a midpoint between the first and second high-pretilt angle regions 242a and 242b along the right-left direction in FIG. 27 and which extends along the thickness direction of the second vertical alignment film 240 passes through a midpoint between the first and second high-pretilt angle regions 222a and 222b along the right-left direction in FIG. 27. In other words, in the thickness direction of the second vertical alignment film 240, the midpoint between the first and second high-pretilt angle regions 242a and 242b along the right-left direction in FIG. 27 is opposed to the midpoint between the first and second high-pretilt angle regions 222a and 222b along the right-left direction in FIG. 27. Alternatively, in the thickness direction of the second vertical alignment film 240, the midpoint between the first and second high-pretilt angle regions 242a and 242b along the right-left direction in FIG. 27 may not be opposed to the midpoint between the first and second high-pretilt angle regions 222a and 222b along the right-left direction in FIG. 27. If this is to be adopted, ensuring that portions of the first and second high-pretilt angle regions 242a and 242b are opposed to at least portions of first and second high-pretilt angle regions 222a and 222b in the thickness direction of the second vertical alignment film 240 would be preferable from the standpoint of suppressing an increase in the geometric area of dark lines.

The fourth upper alignment regulating portion 244 includes a low-pretilt angle region 244c. The low-pretilt angle region 244c is formed so that its pretilt angle and the like are identical to those of the fourth upper alignment regulating portion 44 in the first embodiment. Moreover, the fourth upper alignment regulating portion 244 includes first and second high-pretilt angle regions 244a and 244b, between which the low-pretilt angle region 244c is interposed. The respective pretilt angles in the first and second high-pretilt angle regions 244a and 244b are larger than the pretilt angle in the low-pretilt angle region 244c.

Moreover, along the thickness direction of the second vertical alignment film 240, the first and second high-pretilt angle regions 244a and 244b of the fourth upper alignment regulating portion 244 are disposed so as to be partly opposed to the first and second high-pretilt angle regions 224a and 224b of the fourth lower alignment regulating portion 224.

Moreover, the first and second vertical alignment films 220 and 240 are formed so that, regarding length along the right-left direction in FIG. 27, the first and second high-pretilt angle regions 224a and 224b of the fourth lower alignment regulating portion 224 are shorter than the first and second high-pretilt angle regions 244a and 244b of the fourth upper alignment regulating portion 244. Herein, for example, the lengths of the first and second high-pretilt angle regions 224a and 224b along the right-left direction in FIG. 27 may be a length(s) in the range from 0 μm to 9 μm, while the lengths of the first and second high-pretilt angle regions 244a and 244b along the right-left direction in FIG. 27 may be a length(s) in the range from 14 μm to 23 μm.

Moreover, an imaginary line which passes through a midpoint between the first and second high-pretilt angle regions 244a and 244b along the right-left direction in FIG. 27 and which extends along the thickness direction of the second vertical alignment film 240 passes through a midpoint between the first and second high-pretilt angle regions 224a and 224b along the right-left direction in FIG. 27. In other words, in the thickness direction of the second vertical alignment film 240, the midpoint between the first and second high-pretilt angle regions 244a and 244b along the right-left direction in FIG. 27 is opposed to the midpoint between the first and second high-pretilt angle regions 224a and 224b along the right-left direction in FIG. 27. Alternatively, in the thickness direction of the second vertical alignment film 240, the midpoint between the first and second high-pretilt angle regions 244a and 244b along the right-left direction in FIG. 27 may not be opposed to the midpoint between the first and second high-pretilt angle regions 224a and 224b along the right-left direction in FIG. 27. If this is to be adopted, ensuring that portions of the first and second high-pretilt angle regions 244a and 244b are opposed to at least portions of first and second high-pretilt angle regions 224a and 224b in the thickness direction of the second vertical alignment film 240 would be preferable from the standpoint of suppressing an increase in the geometric area of dark lines.

Herein, for example, the first and second high-pretilt angle regions 242a and 242b of the second upper alignment regulating portion 242 and the first and second high-pretilt angle regions 244a and 244b of the fourth upper alignment regulating portion 244 may be formed in such a manner as to have a pretilt angle of 89.8°. If this is to be adopted, for example, the low-pretilt angle region 242c of the second upper alignment regulating portion 242, the second upper alignment regulating portion 42, the low-pretilt angle region 244c of the fourth upper alignment regulating portion 244, and the fourth upper alignment regulating portion 44 may be formed in such a manner as to have a pretilt angle of 88.0°.

Moreover, the length of the first high-pretilt angle region 242a along the right-left direction in FIG. 27 may be equal to the length of the second high-pretilt angle region 242b along the right-left direction in FIG. 27.

Moreover, the length of the first high-pretilt angle region 244a along the right-left direction in FIG. 27 may be equal to the length of the second high-pretilt angle region 244b along the right-left direction in FIG. 27.

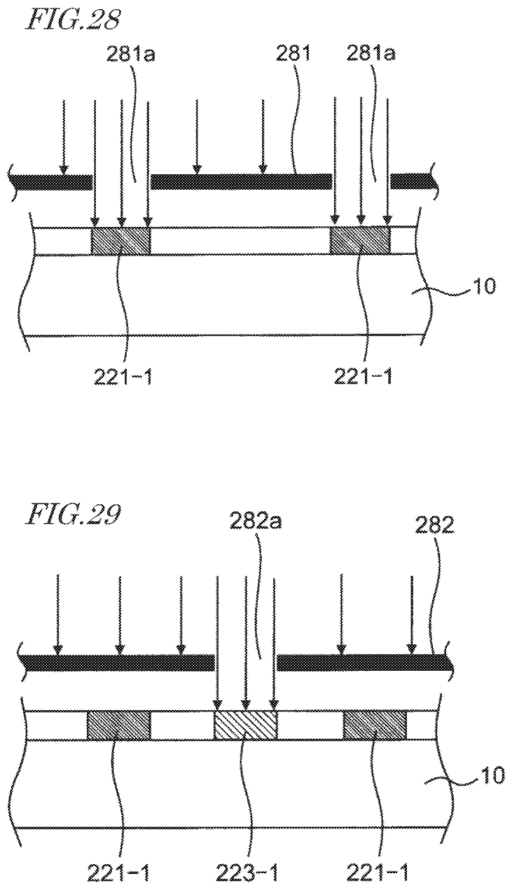

Hereinafter, a production method for the liquid crystal display panel above will be described. Note that arrows in FIG. 28 to FIG. 31 represent directions in which light travels during light irradiation, and also indicate regions through which light passes during light irradiation.

First, similarly to the steps of FIG. 6 and FIG. 7, after a first substrate section 10 is formed, a material film to become the material of the first vertical alignment film 220 is formed on the first substrate section 10.

Next, light irradiation is performed for the first substrate section 10 from above. At this time, as shown in FIG. 28, by using a mask 281 having a plurality of apertures 281a, 281a, . . . , 281a (only two of which are shown in FIG. 28), a first lower alignment regulating portion 221-1 is formed under each aperture 281a. The alignment direction in the respective first lower alignment regulating portion 221-1 coincides with the alignment direction in the first lower alignment regulating portion 221. Note that each aperture 281a is an aperture extending along the transverse direction of the pixel region 101.

Next, as shown in FIG. 29, light irradiation is performed by using a mask 282 having a plurality of apertures 282a, 282a, . . . , 282a (only one of which is shown in FIG. 29) at positions different from those of the apertures 281a in the mask 281. Although this light irradiation is performed for the first substrate section 10 from above as in the case of FIG. 28, it is performed in a direction that is different from the direction of the light irradiation performed through the apertures 281a in the mask 281. Stated otherwise, in a plan view, the direction of light travel during the light irradiation in FIG. 29 differs from the direction of light travel during the light irradiation in FIG. 28. As a result of this, third lower alignment regulating portions 223-1 are formed between the first lower alignment regulating portions 221-1. The alignment direction in the respective third lower alignment regulating portion 223-1 coincides with the alignment direction in the third lower alignment regulating portion 223. Note that each aperture 282a also is an aperture extending along the transverse direction of the pixel region 101.

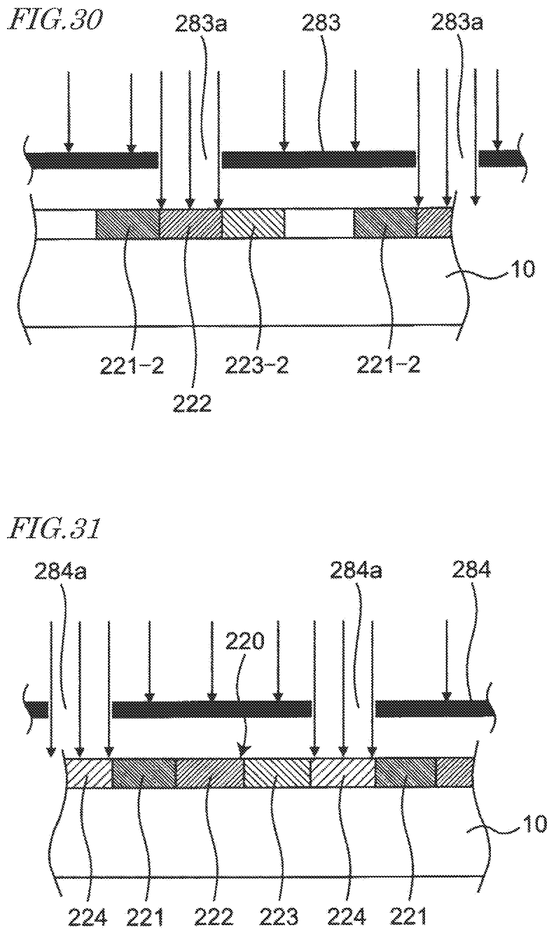

Next, as shown in FIG. 30, light irradiation is performed by using a mask 283 having a plurality of apertures 283a, 283a, . . . , 283a (only two of which are shown in FIG. 30). The aperture positions in the mask 283 are different from the aperture positions in the masks 281 and 282. Although this light irradiation is performed for the first substrate section 10 from above as in the case of FIG. 8 and FIG. 9, it is performed in a direction that is different from the direction of the light irradiation performed through the respective apertures 281a and 282a in the masks 281 and 282.

Moreover, portions of the light having passed through each aperture 283a in the mask 283 are radiated at the right end of the first lower alignment regulating portion 221-1 in FIG. 29 and the left end of the third lower alignment regulating portion 223-1 in FIG. 29. These ends become portions that have been exposed to light twice, i.e., so-called double-exposed portions, to constitute subportions of the second lower alignment regulating portion 222. At this time, the second lower alignment regulating portion 222 is interposed between the first lower alignment regulating portion 221-2 and the third lower alignment regulating portion 223-2. Note that each aperture 283a also is an aperture extending along the transverse direction of the pixel region 101.

Next, as shown in FIG. 31, light irradiation is performed by using a mask 284 having different aperture positions from those in the masks 281 to 283. Although this light irradiation is performed for the first substrate section 10 from above as in the case of FIG. 28 to FIG. 30, it is performed in a direction that is different from the direction of the light irradiation performed through the respective apertures 281a, 282a and 283a in the masks 281, 282 and 283. At this time, light passes through a plurality of apertures 284a, 284a, . . . , 284a (only two of which are shown in FIG. 31) formed in the mask 284.

Moreover, portions of the light having passed through each aperture 284a in the mask 284 are radiated at the right end of the third lower alignment regulating portion 223-2 in FIG. 30 and the left end of the first lower alignment regulating portion 221-2 in FIG. 30. These ends become double-exposed portions to constitute subportions of the fourth lower alignment regulating portion 224. Thus, when the first lower alignment regulating portion 221 is formed, the first vertical alignment film 220 is obtained upon the first substrate section 10. Note that each aperture 284a also is an aperture extending along the transverse direction of the pixel region 101.

Next, after forming a material film to become the material of the second vertical alignment film 240 on the second substrate section 50, steps similar to those in FIG. 28 to FIG. 31 are performed to form the second vertical alignment film 240 as shown in FIG. 27 on the second substrate section 50. At this time, light irradiation is performed in such a manner that the length of any double-exposed region in the material film (i.e., length along a direction corresponding to the directions of arrows L and R in FIG. 27) is longer than the length of any double-exposed region in the material film to become the material of the first vertical alignment film 220 (i.e., length along a direction corresponding to the directions of arrows L and R in FIG. 27).

Thereafter, steps similar to those in FIG. 12 and FIG. 13 are performed, thereby sealing a liquid crystal layer 230 between the first vertical alignment film 220 and the second vertical alignment film 240, as shown in FIG. 27.

Finally, a first polarizer 60 is disposed under the first substrate section 10, and a second polarizer 70 is disposed under the second substrate section 50 (see FIG. 1).

In such a production method, light irradiation is performed in such a manner that the length of any double-exposed region in the first vertical alignment film 220 is shorter than the length of any double-exposed region in the second vertical alignment film 240. Herein, in the first vertical alignment film 220, the double-exposed regions in the second and fourth lower alignment regulating portions 222 and 224 are the first and second high-pretilt angle regions 222a, 224a, 222b and 224b. On the other hand, in the second vertical alignment film 240, the double-exposed regions in the second and fourth upper alignment regulating portions 242 and 244 are the first and second high-pretilt angle regions 242a, 244a, 242b and 244b. Therefore, the first and second high-pretilt angle regions 222a, 224a, 222b and 224b are shorter in length, in a direction along the longitudinal direction of the pixel region 201, than the first and second high-pretilt angle regions 242a, 244a, 242b and 244b. Accordingly, the liquid crystal display panel according to the second embodiment also provides action and effects similar to those of the liquid crystal display panel according to the first embodiment.

Although specific embodiments of this invention have been described, this invention is not to be limited to the above-described first and second embodiments and variations thereof; rather, this invention can be practiced with various alterations within its scope. For example, some of the details described in the first and second embodiments may be deleted or replaced to provide an embodiment of this invention. Moreover, alterations as described for the first embodiment may be applied to the second embodiment to provide an embodiment of this invention. For example, as has been described in the aforementioned variation of the first embodiment, the first and second high-pretilt angle regions 222a, 224a, 242a, 244a, 222b, 224b, 242b and 244b may be formed as unexposed regions, rather than as so-called double-exposed regions.

Moreover, description of Japanese Patent No. 5184618, Japanese Laid-Open Patent Publication No. 2011-85738, and International Publication No. 2017/047532 is also applicable to the liquid crystal display panel of this invention. For example, as examples of materials and production methods of liquid crystal display panels according to this invention, the materials and production methods, etc., described in Japanese Patent No. 5184618 Japanese Laid-Open Patent Publication No. 2011-85738, and International Publication No. 2017/047532 can be adopted.

That is, the above disclosure can be summarized as follows.

A liquid crystal display panel according to one implementation of this invention is

a liquid crystal display panel having a display mode that is a VA mode and including a plurality of rectangular-shaped pixel regions 101, 201, comprising:

a first substrate section 10 including a first substrate 11 and pixel electrodes 102 provided above the first substrate 11;

a liquid crystal layer 30, 230 being provided above the first substrate section 10 and containing liquid crystal molecules 31;

a first vertical alignment film 20, 220 provided between the first substrate section 10 and the liquid crystal layer 30, 230;

a second substrate section 50 being provided above the liquid crystal layer 30, 230 and including a second substrate 51 and a counter electrode 103 provided below the second substrate 51; and

a second vertical alignment film 40, 240 provided between the second substrate section 50 and the liquid crystal layer 30, 230, wherein,

a portion of the liquid crystal layer 30, 230 corresponding to each pixel region 101, 201 includes a first liquid crystal domain 101a, 201a, a second liquid crystal domain 101b, 201b, a third liquid crystal domain 101c, 201c, and a fourth liquid crystal domain 101d, 201d arranged along a longitudinal direction of the pixel region 101, 201;

when a direction orthogonal to the longitudinal direction of the pixel region 101, 201 is defined as a transverse direction of the pixel and an azimuth flush with the transverse direction of the pixel region 101, 201 is defined as 0°, then an alignment azimuth of the liquid crystal molecules 31 in the first liquid crystal domain 101a, 201a is substantially 315°; an alignment azimuth of the liquid crystal molecules 31 in the second liquid crystal domain 101b, 201b is substantially 45°; an alignment azimuth of the liquid crystal molecules 31 in the third liquid crystal domain 101c, 201c is substantially 225°; and an alignment azimuth of the liquid crystal molecules 31 in the fourth liquid crystal domain 101d, 201d is substantially 135°;

the first vertical alignment film 20, 220 includes a first lower alignment regulating portion 21, 221, a second lower alignment regulating portion 22, 222, a third lower alignment regulating portion 23, 223, and a fourth lower alignment regulating portion 24, 224 to regulate alignments of the liquid crystal molecules 31 in the first liquid crystal domain 101a, 201a, the second liquid crystal domain 101b, 201b, the third liquid crystal domain 101c, 201c, and the fourth liquid crystal domain 101d, 201d from below;

the second vertical alignment film 40, 240 includes a first upper alignment regulating portion 41, 241, a second upper alignment regulating portion 42, 242, a third upper alignment regulating portion 43, 243, and a fourth upper alignment regulating portion 44, 244 to regulate alignments of the liquid crystal molecules 31 in the first liquid crystal domain 101a, 201a, the second liquid crystal domain 101b, 201b, the third liquid crystal domain 101c, 201c, and the fourth liquid crystal domain 101d, 201d from above;

the first and third lower alignment regulating portions 21, 23 and the first and third upper alignment regulating portions 41, 43, or the second and fourth lower alignment regulating portions 222, 224 and the second and fourth upper alignment regulating portions 242, 244 each include

a first high-pretilt angle region 21a, 23a, 41a, 43a, 222a, 224a, 242a, 244a provided at one side in a direction along the longitudinal direction of the pixel region 101, 201,

a second high-pretilt angle region 21b, 23b, 41b, 43b, 222b, 224b, 242b, 244b provided at another side in the direction along the longitudinal direction of the pixel region 101, 201, and

a low-pretilt angle region 21c, 23c, 41c, 43c, 222c, 224c, 242c, 244c being provided between the first high-pretilt angle region 21a, 23a, 41a, 43a, 222a, 224a, 242a, 244a and the second high-pretilt angle region 21b, 23b, 41b, 43b, 222b, 224b, 242b, 244b and having a smaller pretilt angle than do the first and second high-pretilt angle regions 21a, 23a, 41a, 43a, 222a, 224a, 242a, 244a, 21b, 23b, 41b, 43b, 222b, 224b, 242b, 244b;

when the first and third lower alignment regulating portions 21, 23 and the first and third upper alignment regulating portions 41, 43 each include the first and second high-pretilt angle regions 21a, 23a, 41a, 43a, 21b, 23b, 41b, 43b and the low-pretilt angle region 21c, 23c, 41c, 43c,

the first and second high-pretilt angle regions 21a, 21b of the first lower alignment regulating portion 21 are opposed to the first and second high-pretilt angle regions 41a, 41b of the first upper alignment regulating portion 41, and are shorter in length than the first and second high-pretilt angle regions 41a, 41b of the first upper alignment regulating portion 41 in the direction along the longitudinal direction of the pixel region 101, 201; and

the first and second high-pretilt angle regions 23a, 23b of the third lower alignment regulating portion 23 are opposed to the first and second high-pretilt angle regions 43a, 43b of the third upper alignment regulating portion 43, and are shorter in length than the first and second high-pretilt angle regions 43a, 43b of the third upper alignment regulating portion 43 in the direction along the longitudinal direction of the pixel region 101, 201; and

when the second and fourth lower alignment regulating portions 222, 224 and the second and fourth upper alignment regulating portions 242, 244 each include the first and second high-pretilt angle regions 222a, 224a, 242a, 244a, 222b, 224b, 242b, 244b and the low-pretilt angle region 222c, 224c, 242c, 244c,

the first and second high-pretilt angle regions 222a, 222b of the second lower alignment regulating portion 222 are opposed to the first and second high-pretilt angle regions 242a, 242b of the second upper alignment regulating portion 242, and are shorter in length than the first and second high-pretilt angle regions 242a, 242b of the second upper alignment regulating portion 242 in the direction along the longitudinal direction of the pixel region 101, 201; and

the first and second high-pretilt angle regions 224a, 242a, 244a, 244b of the fourth lower alignment regulating portion 224 are opposed to the first and second high-pretilt angle regions 244a, 244b of the fourth upper alignment regulating portion 244, and are shorter in length than the first and second high-pretilt angle regions 244a, 244b of the fourth upper alignment regulating portion 244 in the direction along the longitudinal direction of the pixel region 101, 201.

Herein, the aforementioned alignment azimuth of the liquid crystal molecule 31 refers to, in a plan view of the liquid crystal molecule 31 under an applied voltage across the liquid crystal layer 30, 230, a direction from one end of the liquid crystal molecule 31 along its major axis direction that is at the first substrate section 10 side to the other end of the liquid crystal molecule 31 along its major axis direction that is at the second substrate section 50 side. In this case, when the alignment azimuth of the liquid crystal molecule 31 is said to be 0°, this alignment azimuth corresponds to the rightward direction from one end of the liquid crystal molecule 31 along its major axis direction that is at the first substrate section 10 side (so-called the 3 o'clock direction). In that case, when the alignment azimuth of a liquid crystal molecule 31 is said to be 450, this alignment azimuth corresponds to an alignment azimuth that results through a 45° counterclockwise rotation from the 0° alignment azimuth of the liquid crystal molecule 31.

As referred to above, substantially 45° means an angle in the range from 30° to 60°, or an angle in the range from 40° to 50°. As referred to above, substantially 135° means an angle in the range from 150° to 120°, or an angle in the range from 140° to 130°. As referred to above, substantially 225° means an angle in the range from 210° to 240°, or an angle in the range from 220° to 230°. As referred to above, substantially 315° means an angle in the range from 300° to 330°, or an angle in the range from 310° to 3200.

Moreover, the aforementioned pretilt angle means, in an interface which is in contact with an alignment regulating portion of the liquid crystal layer 30, 230, an angle of alignment of molecular orientation with respect to a plane that is orthogonal to the thickness direction of the liquid crystal layer 30, 230.

With the above configuration, the first and second high-pretilt angle regions 21a, 23a, 222a, 224a, 242a, 21b, 23b, 222b, 224b of the first vertical alignment film 20, 220 are shorter in length, in a direction along the longitudinal direction of the pixel region 101, 201, than the first and second high-pretilt angle regions 41a, 43a, 242a, 244a, 41b, 43b, 242b, 244b of the second vertical alignment film 40, 240. As a result, even if a deviation in position due to a manufacturing error, etc., occurs between the first vertical alignment film 20, 220 and the second vertical alignment film 40, 240, it is less likely for the first and second high-pretilt angle regions 21a, 23a, 222a, 224a, 21b, 23b, 222b, 224b of the first vertical alignment film 20, 220 to fail to be opposed to the first and second high-pretilt angle regions 41a, 43a, 242a, 244a, 41b, 43b, 242b, 244b of the second vertical alignment film 40, 240. Thus, in the displaying corresponding to the pixel regions 101, 201, an increase in the geometric area of dark lines can be suppressed.

In a liquid crystal display panel according to an embodiment,

when the first and third lower alignment regulating portions 21, 23 and the first and third upper alignment regulating portions 41, 43 each include the first and second high-pretilt angle regions 21a, 23a, 41a, 43a, 21b, 23b, 41b, 43b and the low-pretilt angle region 21c, 23c, 41c, 43c,

the second and fourth lower alignment regulating portions 22, 24 each have a pretilt angle which is essentially equal to the pretilt angle in the low-pretilt angle regions 21c, 23c of the first and third lower alignment regulating portions 21, 23; and

the second and fourth upper alignment regulating portions 42, 44 each have a pretilt angle which is essentially equal to the pretilt angle in the low-pretilt angle regions 41c, 43c of the first and third upper alignment regulating portions 41, 43.

According to the above embodiment, the pretilt angle in each of the second and fourth lower alignment regulating portions 22, 24 and the pretilt angle in each of the low-pretilt angle regions 21c and 23c of the first and third lower alignment regulating portions 21 and 23 are essentially equal. Moreover, the pretilt angle in each of the second and fourth upper alignment regulating portions 42 and 44 and the pretilt angle in the low-pretilt angle regions 41c and 43c of the first and third upper alignment regulating portions 41 and 43 are essentially equal. Therefore, a decrease in the alignment regulating forces of the second and fourth lower alignment regulating portions 22 and 24 and the second and fourth upper alignment regulating portions 42 and 44 can be suppressed.

In a liquid crystal display panel according to an embodiment,

when the second and fourth lower alignment regulating portions 222, 224 and the second and fourth upper alignment regulating portions 242, 244 each include the first and second high-pretilt angle regions 222a, 224a, 242a, 244a, 222b, 224b, 242b, 244b and the low-pretilt angle region 222c, 224c, 242c, 244c,

the first and third lower alignment regulating portions 221, 223 each have a pretilt angle which is essentially equal to the pretilt angle in the low-pretilt angle regions 222c, 224c of the second and fourth lower alignment regulating portions 222, 224; and

the first and third upper alignment regulating portions 241, 243 each have a pretilt angle which is essentially equal to the pretilt angle in the low-pretilt angle regions 242c, 244c of the second and fourth upper alignment regulating portions.

According to the above embodiment, the pretilt angle in each of the first and third lower alignment regulating portions 221 and 223 and the pretilt angle in the low-pretilt angle regions 222c and 224c of the second and fourth lower alignment regulating portions 222 and 224 are essentially equal. Moreover, the pretilt angle in each of the first and third upper alignment regulating portions 241 and 243 and the pretilt angle in the low-pretilt angle regions 242c and 244c of the second and fourth upper alignment regulating portions are essentially equal. Therefore, a decrease in the alignment regulating forces of the first and third lower alignment regulating portions 221 and 223 and the first and third upper alignment regulating portions 241 and 243 can be suppressed.

In a liquid crystal display panel according to an embodiment,

the pixel electrodes 102 have a slit formed therein, and the counter electrode 103 has no slit formed therein.

According to the above embodiment, because slits are formed in the pixel electrodes 102, whereas no slits are formed in the counter electrode 103, an increase in the geometric area of dark lines can be effectively prevented.

In a liquid crystal display panel according to an embodiment,

the first and second high-pretilt angle regions 21a, 23a, 41a, 43a, 222a, 224a, 242a, 244a, 21b, 23b, 41b, 43b, 222b, 224b, 242b, 244b are double-exposed regions formed through two instances of exposure to light.

According to the above embodiment, because the first and second high-pretilt angle regions 21a, 23a, 41a, 43a, 222a, 224a, 242a, 244a, 21b, 23b, 41b, 43b, 222b, 224b, 242b, 244b are double-exposed regions which have been formed through two instances of exposure to light, unexposed regions can be prevented from occurring in the first vertical alignment film 20, 220 and the second vertical alignment film 40, 240.

A production method for a liquid crystal display panel according to one implementation of this invention is a production method for a liquid crystal display panel having a display mode that is a VA mode and including a plurality of rectangular-shaped pixel regions 101, comprising:

a first substrate section 10 including a first substrate 11 and pixel electrodes 102 provided above the first substrate 11;

a liquid crystal layer 30 being provided above the first substrate section 10 and containing liquid crystal molecules 31;

a first vertical alignment film 20 provided between the first substrate section 10 and the liquid crystal layer 30;

a second substrate section 50 being provided above the liquid crystal layer 30 and including a second substrate 51 and a counter electrode 103 provided below the second substrate 51; and

a second vertical alignment film 40 provided between the second substrate section 50 and the liquid crystal layer 30, wherein,

a portion of the liquid crystal layer 30 corresponding to each pixel region 101 includes a first liquid crystal domain 101a, a second liquid crystal domain 101b, a third liquid crystal domain 101c, and a fourth liquid crystal domain 101d arranged along a longitudinal direction of the pixel region 101;

when a direction orthogonal to the longitudinal direction of the pixel region 101 is defined as a transverse direction of the pixel and an azimuth flush with the transverse direction of the pixel region 101 is defined as 0°, then an alignment azimuth of the liquid crystal molecules 31 in the first liquid crystal domain 101a is substantially 315°; an alignment azimuth of the liquid crystal molecules 31 in the second liquid crystal domain 101b is substantially 45°; an alignment azimuth of the liquid crystal molecules 31 in the third liquid crystal domain 101c is substantially 225°; and an alignment azimuth of the liquid crystal molecules 31 in the fourth liquid crystal domain 101d is substantially 135°;

the first vertical alignment film 20 includes a first lower alignment regulating portion 21, a second lower alignment regulating portion 22, a third lower alignment regulating portion 23, and a fourth lower alignment regulating portion 24 to regulate alignments of the liquid crystal molecules 31 in the first liquid crystal domain 101a, the second liquid crystal domain 101b, the third liquid crystal domain 101c, and the fourth liquid crystal domain 101d from below;

the second vertical alignment film 40 includes a first upper alignment regulating portion 41, a second upper alignment regulating portion 42, a third upper alignment regulating portion 43, and a fourth upper alignment regulating portion 44 to regulate alignments of the liquid crystal molecules 31 in the first liquid crystal domain 101a, the second liquid crystal domain 101b, the third liquid crystal domain 101c, and the fourth liquid crystal domain 101d from above; and

the first and third lower alignment regulating portions 21, 23 and the first and third upper alignment regulating portions 41, 43 each include

a first high-pretilt angle region 21a, 23a, 41a, 43a provided at one side in a direction along the longitudinal direction of the pixel region 101,

a second high-pretilt angle region 21b, 23b, 41b, 43b provided at another side in the direction along the longitudinal direction of the pixel region 101, and

a low-pretilt angle region 21c, 23c, 41c, 43c being provided between the first high-pretilt angle region 21a, 23a, 41a, 43a and the second high-pretilt angle region 21b, 23b, 41b, 43b and having a smaller pretilt angle than do the first and second high-pretilt angle regions 21a, 23a, 41a, 43a, 21b, 23b, 41b, 43b, the production method comprising:

a step of forming the first vertical alignment film 20 and the second vertical alignment film 40 so that the first and second high-pretilt angle regions 21a, 21b of the first lower alignment regulating portion 21 are shorter in length than the first and second high-pretilt angle regions 41a, 43b of the first upper alignment regulating portion 41 in the direction along the longitudinal direction of the pixel region 101, and that the first and second high-pretilt angle regions 23a, 23b of the third lower alignment regulating portion 23 are shorter in length than the first and second high-pretilt angle regions 43a, 43b of the third upper alignment regulating portion 43 in the direction along the longitudinal direction of the pixel region 101; and

a step of, after the step of forming the first vertical alignment film 20 and the second vertical alignment film 40 is performed, disposing the second substrate 51 on the first substrate section 10 via the liquid crystal layer 30 so that the first and second high-pretilt angle regions 21a, 21b of the first lower alignment regulating portion 21 are opposed to the first and second high-pretilt angle regions 41a, 41b regions of the first upper alignment regulating portion 41, and that the first and second high-pretilt angle regions 23a, 23b of the third lower alignment regulating portion 23 are opposed to the first and second high-pretilt angle regions 43a, 43b of the third upper alignment regulating portion 43.

Herein, the aforementioned alignment azimuth of the liquid crystal molecule 31 refers to, in a plan view of the liquid crystal molecule 31 under an applied voltage across the liquid crystal layer 30, a direction from one end of the liquid crystal molecule 31 along its major axis direction that is at the first substrate section 10 side, to the other end of the liquid crystal molecule 31 along its major axis direction that is at the second substrate section 50 side. In this case, when the alignment azimuth of the liquid crystal molecule 31 is said to be 0°, this alignment azimuth corresponds to the rightward direction from one end of the liquid crystal molecule 31 along its major axis direction that is at the first substrate section 10 side (so-called the 3 o'clock direction). In that case, when the alignment azimuth of a liquid crystal molecule 31 is said to be 45°, this alignment azimuth corresponds to an alignment azimuth that results through a 45° counterclockwise rotation from the 0° alignment azimuth of the liquid crystal molecule 31.

As referred to above, substantially 45° means an angle in the range from 30° to 60°, or an angle in the range from 40° to 50°. As referred to above, substantially 135° means an angle in the range from 150° to 120°, or an angle in the range from 140° to 130°. As referred to above, substantially 225° means an angle in the range from 210° to 240°, or an angle in the range from 220° to 230°. As referred to above, substantially 315° means an angle in the range from 300° to 330°, or an angle in the range from 310° to 320°.

Moreover, the aforementioned pretilt angle means, in an interface which is in contact with an alignment regulating portion of the liquid crystal layer 30, an angle of alignment of molecular orientation with respect to a plane that is orthogonal to the thickness direction of the liquid crystal layer 30.

With the above configuration, the first vertical alignment film 20 and the second vertical alignment film 40 are formed so that the first and second high-pretilt angle regions 21a and 21b of the first lower alignment regulating portion 21 are shorter in length, in a direction along the longitudinal direction of the pixel region 101, than the first and second high-pretilt angle regions 41a and 41b of the first upper alignment regulating portion 41, and that the first and second high-pretilt angle regions 23a and 23b of the third lower alignment regulating portion 23 are shorter in length, in the direction along the longitudinal direction of the pixel region 101, than the first and second high-pretilt angle regions 43a and 43b of the third upper alignment regulating portion 43. Therefore, after the step of forming the first vertical alignment film 20 and the second vertical alignment film 40 is performed, when the second substrate 51 is disposed on the first substrate section 10 via the liquid crystal layer 30, even if a deviation in position due to a manufacturing error, etc., occurs between the first vertical alignment film 20 and the second vertical alignment film 40, it is less likely for the first and second high-pretilt angle regions 21a, 23a, 21b and 23b of the first vertical alignment film 20 to fail to be opposed to the first and second high-pretilt angle regions 41a, 43a, 41b and 43b of the second vertical alignment film 40. Thus, in the displaying corresponding to the pixel regions 101, an increase in the geometric area of dark lines can be suppressed.

A production method for a liquid crystal display panel according to one implementation of this invention is a production method for a liquid crystal display panel having a display mode that is a VA mode and including a plurality of rectangular-shaped pixel regions 201, comprising:

a first substrate section 10 including a first substrate 11 and pixel electrodes 102 provided above the first substrate 11;

a liquid crystal layer 230 being provided above the first substrate section 10 and containing liquid crystal molecules 31;

a first vertical alignment film 220 provided between the first substrate section 10 and the liquid crystal layer 230;

a second substrate section 50 being provided above the liquid crystal layer 230 and including a second substrate 51 and a counter electrode 103 provided below the second substrate 51; and

a second vertical alignment film 240 provided between the second substrate section 50 and the liquid crystal layer 230, wherein,

a portion of the liquid crystal layer 230 corresponding to each pixel region 201 includes a first liquid crystal domain 201a, a second liquid crystal domain 201b, a third liquid crystal domain 201c, and a fourth liquid crystal domain 201d arranged along a longitudinal direction of the pixel region 201;

when a direction orthogonal to the longitudinal direction of the pixel region 201 is defined as a transverse direction of the pixel and an azimuth flush with the transverse direction of the pixel region 201 is defined as 0°, then an alignment azimuth of the liquid crystal molecules 31 in the first liquid crystal domain 201a is substantially 315°; an alignment azimuth of the liquid crystal molecules 31 in the second liquid crystal domain 201b is substantially 45°; an alignment azimuth of the liquid crystal molecules 31 in the third liquid crystal domain 201c is substantially 225°; and an alignment azimuth of the liquid crystal molecules 31 in the fourth liquid crystal domain 201d is substantially 135°;

the first vertical alignment film 220 includes a first lower alignment regulating portion 21, 221, a second lower alignment regulating portion 222, a third lower alignment regulating portion 23, 223, and a fourth lower alignment regulating portion 224 to regulate alignments of the liquid crystal molecules 31 in the first liquid crystal domain 201a, the second liquid crystal domain 201b, the third liquid crystal domain 201c, and the fourth liquid crystal domain 201d from below;

the second vertical alignment film 240 includes a first upper alignment regulating portion 41, 241, a second upper alignment regulating portion 242, a third upper alignment regulating portion 43, 243, and a fourth upper alignment regulating portion 244 to regulate alignments of the liquid crystal molecules 31 in the first liquid crystal domain 201a, the second liquid crystal domain 201b, the third liquid crystal domain 201c, and the fourth liquid crystal domain 201d from above; and

the second and fourth lower alignment regulating portions 222, 224 and the second and fourth upper alignment regulating portions 242, 244 each include

a first high-pretilt angle region 222a, 224a, 242a, 244a provided at one side in a direction along the longitudinal direction of the pixel region 201,

a second high-pretilt angle region 222b, 224b, 242b, 244b provided at another side in the direction along the longitudinal direction of the pixel region 201, and

a low-pretilt angle region 221c, 223c, 241c, 243c being provided between the first high-pretilt angle region 222a, 224a, 242a, 244a and the second high-pretilt angle region 222b, 224b, 242b, 244b and having a smaller pretilt angle than do the first and second high-pretilt angle regions 222a, 224a, 242a, 244a, 222b, 224b, 242b, 244b, the production method comprising:

a step of forming the first vertical alignment film 220 and the second vertical alignment film 240 so that the first and second high-pretilt angle regions 222a, 222b of the second lower alignment regulating portion 222 are shorter in length than the first and second high-pretilt angle regions 242a, 242b of the second upper alignment regulating portion 242 in the direction along the longitudinal direction of the pixel region 201, and that the first and second high-pretilt angle regions 224a, 224b of the fourth lower alignment regulating portion 224 are shorter in length than the first and second high-pretilt angle regions 244a, 244b of the fourth upper alignment regulating portion 244 in the direction along the longitudinal direction of the pixel region 201; and

a step of, after the step of forming the first vertical alignment film 220 and the second vertical alignment film 240 is performed, disposing the second substrate 51 on the first substrate section 10 via the liquid crystal layer 230 so that the first and second high-pretilt angle regions 222a, 222b of the second lower alignment regulating portion 222 are opposed to the first and second high-pretilt angle regions 242a, 242b of the second upper alignment regulating portion 242, and that the first and second high-pretilt angle regions 224a, 224b of the fourth lower alignment regulating portion 224 are opposed to the first and second high-pretilt angle regions 244a, 244b of the fourth upper alignment regulating portion 244.

Herein, the aforementioned alignment azimuth of the liquid crystal molecule 31 refers to, in a plan view of the liquid crystal molecule 31 under an applied voltage across the liquid crystal layer 230, a direction from one end of the liquid crystal molecule 31 along its major axis direction that is at the first substrate section 10 side, to the other end of the liquid crystal molecule along its major axis direction that is at the second substrate section 50 side. In this case, when the alignment azimuth of the liquid crystal molecule 31 is said to be 0°, this alignment azimuth corresponds to the rightward direction from one end of the liquid crystal molecule 31 along its major axis direction that is at the first substrate section 10 side (so-called the 3 o'clock direction). In that case, when the alignment azimuth of a liquid crystal molecule 31 is said to be 45°, this alignment azimuth corresponds to an alignment azimuth that results through a 45° counterclockwise rotation from the 0° alignment azimuth of the liquid crystal molecule 31.

As referred to above, substantially 45° means an angle in the range from 30° to 60°, or an angle in the range from 40° to 50°. As referred to above, substantially 135° means an angle in the range from 150° to 120°, or an angle in the range from 140° to 130°. As referred to above, substantially 225° means an angle in the range from 210° to 240°, or an angle in the range from 220° to 230°. As referred to above, substantially 315° means an angle in the range from 300° to 330°, or an angle in the range from 310° to 320°.

Moreover, the aforementioned pretilt angle means, in an interface which is in contact with an alignment regulating portion of the liquid crystal layer 230, an angle of alignment of molecular orientation with respect to a plane that is orthogonal to the thickness direction of the liquid crystal layer 230.

With the above configuration, the first vertical alignment film 220 and the second vertical alignment film 240 are formed so that the first and second high-pretilt angle regions 222a and 222b of the second lower alignment regulating portion 222 are shorter in length, in a direction along the longitudinal direction of the pixel region 201, than the first and second high-pretilt angle regions 242a and 242b of the second upper alignment regulating portion 242, and that the first and second high-pretilt angle regions 224a and 224b of the fourth lower alignment regulating portion 224 are shorter in length, in the direction along the longitudinal direction of the pixel region 201, than the first and second high-pretilt angle regions 244a and 244b of the fourth upper alignment regulating portion 244. Therefore, after the step of forming the first vertical alignment film 220 and the second vertical alignment film 240 is performed, when the second substrate 51 is formed on the first substrate section 10 via the liquid crystal layer 230, even if a deviation in position due to a manufacturing error, etc., occurs between the first vertical alignment film 220 and the second vertical alignment film 240, it is less likely for the first and second high-pretilt angle regions 222a, 224a, 222b, 224b of the first vertical alignment film 220 to fail to be opposed to the first and second high-pretilt angle regions 242a, 244a, 242b, 244b of the second vertical alignment film 240. Thus, in the displaying corresponding to the pixel regions 201, an increase in the geometric area of dark lines can be suppressed.

### REFERENCE SIGNS LIST

10 first substrate section
11 first glass substrate
20 first vertical alignment film
21, 221 first lower alignment regulating portion
21a, 23a, 41a, 43a, 222a, 224a, 242a, 244a first high-pretilt angle region
21b, 23b, 41b, 43b, 222b, 224b, 242b, 244b second high-pretilt angle region
21c, 23c, 41c, 43c, 222c, 224c, 242c, 244c low-pretilt angle region
22, 222 second lower alignment regulating portion
23, 223 third lower alignment regulating portion
30 liquid crystal layer
31 liquid crystal molecule
41, 241 first upper alignment regulating portion
42, 242 second upper alignment regulating portion
43, 243 third upper alignment regulating portion
44, 244 fourth upper alignment regulating portion
41 liquid crystal molecule
40 second vertical alignment film
50 second substrate section
51 second glass substrate
90 sealing member
101, 201 pixel region
101a, 201a first liquid crystal domain
101b, 201b second liquid crystal domain
101c, 201c third liquid crystal domain
101d, 201d fourth liquid crystal domain
102 pixel electrode
103 counter electrode
102a first pixel electrode portion
102b second pixel electrode portion
102c bridging portion
102d first recess
102e second recess
111, 141 first slitted region
112A to 112H, 122A to 122H, 142A to 142H, 152A to 152H slit
121, 152 second slitted region
C101 center line

1. A liquid crystal display panel having a display mode that is a VA mode and including a plurality of rectangular-shaped pixel regions, comprising:
a first substrate section including a first substrate and pixel electrodes provided above the first substrate;
a liquid crystal layer being provided above the first substrate section and containing liquid crystal molecules;
a first vertical alignment film provided between the first substrate section and the liquid crystal layer;
a second substrate section being provided above the liquid crystal layer and including a second substrate and a counter electrode provided below the second substrate; and
a second vertical alignment film provided between the second substrate section and the liquid crystal layer, wherein,
a portion of the liquid crystal layer corresponding to each pixel region includes a first liquid crystal domain, a second liquid crystal domain, a third liquid crystal domain, and a fourth liquid crystal domain arranged along a longitudinal direction of the pixel region;
when a direction orthogonal to the longitudinal direction of the pixel region is defined as a transverse direction of the pixel and an azimuth flush with the transverse direction of the pixel region is defined as 0°, then an alignment azimuth of the liquid crystal molecules in the first liquid crystal domain is substantially 315°; an alignment azimuth of the liquid crystal molecules in the second liquid crystal domain is substantially 45°; an alignment azimuth of the liquid crystal molecules in the third liquid crystal domain is substantially 225°; and an alignment azimuth of the liquid crystal molecules in the fourth liquid crystal domain is substantially 135′;
the first vertical alignment film includes a first lower alignment regulating portion, a second lower alignment regulating portion, a third lower alignment regulating portion, and a fourth lower alignment regulating portion to regulate alignments of the liquid crystal molecules in the first liquid crystal domain, the second liquid crystal domain, the third liquid crystal domain, and the fourth liquid crystal domain from below;
the second vertical alignment film includes a first upper alignment regulating portion, a second upper alignment regulating portion, a third upper alignment regulating portion, and a fourth upper alignment regulating portion to regulate alignments of the liquid crystal molecules in the first liquid crystal domain, the second liquid crystal domain, the third liquid crystal domain, and the fourth liquid crystal domain from above;
the first and third lower alignment regulating portions and the first and third upper alignment regulating portions, or the second and fourth lower alignment regulating portions and the second and fourth upper alignment regulating portions each include
a first high-pretilt angle region provided at one side in a direction along the longitudinal direction of the pixel region,
a second high-pretilt angle region provided at another side in the direction along the longitudinal direction of the pixel region, and
a low-pretilt angle region being provided between the first high-pretilt angle region and the second high-pretilt angle region and having a smaller pretilt angle than do the first and second high-pretilt angle regions;
when the first and third lower alignment regulating portions and the first and third upper alignment regulating portions each include the first and second high-pretilt angle regions and the low-pretilt angle region,
the first and second high-pretilt angle regions of the first lower alignment regulating portion are opposed to the first and second high-pretilt angle regions of the first upper alignment regulating portion, and are shorter in length than the first and second high-pretilt angle regions of the first upper alignment regulating portion in the direction along the longitudinal direction of the pixel region; and
the first and second high-pretilt angle regions of the third lower alignment regulating portion are opposed to the first and second high-pretilt angle regions of the third upper alignment regulating portion, and are shorter in length than the first and second high-pretilt angle regions of the third upper alignment regulating portion in the direction along the longitudinal direction of the pixel region; and
when the second and fourth lower alignment regulating portions and the second and fourth upper alignment regulating portions each include the first and second high-pretilt angle regions and the low-pretilt angle region,
the first and second high-pretilt angle regions of the second lower alignment regulating portion are opposed to the first and second high-pretilt angle regions of the second upper alignment regulating portion, and are shorter in length than the first and second high-pretilt angle regions of the second upper alignment regulating portion in the direction along the longitudinal direction of the pixel region; and
the first and second high-pretilt angle regions of the fourth lower alignment regulating portion are opposed to the first and second high-pretilt angle regions of the fourth upper alignment regulating portion, and are shorter in length than the first and second high-pretilt angle regions of the fourth upper alignment regulating portion in the direction along the longitudinal direction of the pixel region.

2. The liquid crystal display panel of claim 1, wherein,
when the first and third lower alignment regulating portions and the first and third upper alignment regulating portions each include the first and second high-pretilt angle regions and the low-pretilt angle region,
the second and fourth lower alignment regulating portions each have a pretilt angle which is essentially equal to the pretilt angle in the low-pretilt angle regions of the first and third lower alignment regulating portions; and
the second and fourth upper alignment regulating portions each have a pretilt angle which is essentially equal to the pretilt angle in the low-pretilt angle regions of the first and third upper alignment regulating portions.

3. The liquid crystal display panel of claim 1, wherein,
when the second and fourth lower alignment regulating portions and the second and fourth upper alignment regulating portions each include the first and second high-pretilt angle regions and the low-pretilt angle region,
the first and third lower alignment regulating portions each have a pretilt angle which is essentially equal to the pretilt angle in the low-pretilt angle regions of the second and fourth lower alignment regulating portions; and
the first and third upper alignment regulating portions each have a pretilt angle which is essentially equal to the pretilt angle in the low-pretilt angle regions of the second and fourth upper alignment regulating portions.

4. The liquid crystal display panel of claim 1, wherein
the pixel electrodes have a slit formed therein, and the counter electrode has no slit formed therein.

5. The liquid crystal display panel of claim 1, wherein
the first and second high-pretilt angle regions are double-exposed regions formed through two instances of exposure to light.

6. A production method for a liquid crystal display panel having a display mode that is a VA mode and including a plurality of rectangular-shaped pixel regions, the liquid crystal display panel including:
a first substrate section including a first substrate and pixel electrodes provided above the first substrate;
a liquid crystal layer being provided above the first substrate section and containing liquid crystal molecules;
a first vertical alignment film provided between the first substrate section and the liquid crystal layer;
a second substrate section being provided above the liquid crystal layer and including a second substrate and a counter electrode provided below the second substrate; and
a second vertical alignment film provided between the second substrate section and the liquid crystal layer, wherein,
a portion of the liquid crystal layer corresponding to each pixel region includes a first liquid crystal domain, a second liquid crystal domain, a third liquid crystal domain, and a fourth liquid crystal domain arranged along a longitudinal direction of the pixel region;
when a direction orthogonal to the longitudinal direction of the pixel region is defined as a transverse direction of the pixel and an azimuth flush with the transverse direction of the pixel region is defined as 0°, then an alignment azimuth of the liquid crystal molecules in the first liquid crystal domain is substantially 315′; an alignment azimuth of the liquid crystal molecules in the second liquid crystal domain is substantially 45°; an alignment azimuth of the liquid crystal molecules in the third liquid crystal domain is substantially 225°; and an alignment azimuth of the liquid crystal molecules in the fourth liquid crystal domain is substantially 135′;
the first vertical alignment film includes a first lower alignment regulating portion, a second lower alignment regulating portion, a third lower alignment regulating portion, and a fourth lower alignment regulating portion to regulate alignments of the liquid crystal molecules in the first liquid crystal domain, the second liquid crystal domain, the third liquid crystal domain, and the fourth liquid crystal domain from below;
the second vertical alignment film includes a first upper alignment regulating portion, a second upper alignment regulating portion, a third upper alignment regulating portion, and a fourth upper alignment regulating portion to regulate alignments of the liquid crystal molecules in the first liquid crystal domain, the second liquid crystal domain, the third liquid crystal domain, and the fourth liquid crystal domain from above; and
the first and third lower alignment regulating portions and the first and third upper alignment regulating portions each include
a first high-pretilt angle region provided at one side in a direction along the longitudinal direction of the pixel region,
a second high-pretilt angle region provided at another side in the direction along the longitudinal direction of the pixel region, and
a low-pretilt angle region being provided between the first high-pretilt angle region and the second high-pretilt angle region and having a smaller pretilt angle than do the first and second high-pretilt angle regions, the production method comprising:
a step of forming the first vertical alignment film and the second vertical alignment film so that the first and second high-pretilt angle regions of the first lower alignment regulating portion are shorter in length than the first and second high-pretilt angle regions of the first upper alignment regulating portion in the direction along the longitudinal direction of the pixel region, and that the first and second high-pretilt angle regions of the third lower alignment regulating portion are shorter in length than the first and second high-pretilt angle regions of the third upper alignment regulating portion in the direction along the longitudinal direction of the pixel region; and
a step of, after the step of forming the first vertical alignment film and the second vertical alignment film is performed, disposing the second substrate on the first substrate section via the liquid crystal layer so that the first and second high-pretilt angle regions of the first lower alignment regulating portion are opposed to the first and second high-pretilt angle regions of the first upper alignment regulating portion, and that the first and second high-pretilt angle regions of the third lower alignment regulating portion are opposed to the first and second high-pretilt angle regions of the third upper alignment regulating portion.

7. A production method for a liquid crystal display panel having a display mode that is a VA mode and including a plurality of rectangular-shaped pixel regions, the liquid crystal display panel including:
a first substrate section including a first substrate and pixel electrodes provided above the first substrate;
a liquid crystal layer being provided above the first substrate section and containing liquid crystal molecules;
a first vertical alignment film provided between the first substrate section and the liquid crystal layer;
a second substrate section being provided above the liquid crystal layer and including a second substrate and a counter electrode provided below the second substrate; and
a second vertical alignment film provided between the second substrate section and the liquid crystal layer, wherein,
a portion of the liquid crystal layer corresponding to each pixel region includes a first liquid crystal domain, a second liquid crystal domain, a third liquid crystal domain, and a fourth liquid crystal domain arranged along a longitudinal direction of the pixel region;
when a direction orthogonal to the longitudinal direction of the pixel region is defined as a transverse direction of the pixel and an azimuth flush with the transverse direction of the pixel region is defined as 0°, then an alignment azimuth of the liquid crystal molecules in the first liquid crystal domain is substantially 315′; an alignment azimuth of the liquid crystal molecules in the second liquid crystal domain is substantially 45°; an alignment azimuth of the liquid crystal molecules in the third liquid crystal domain is substantially 225°; and an alignment azimuth of the liquid crystal molecules in the fourth liquid crystal domain is substantially 135′;
the first vertical alignment film includes a first lower alignment regulating portion, a second lower alignment regulating portion, a third lower alignment regulating portion, and a fourth lower alignment regulating portion to regulate alignments of the liquid crystal molecules in the first liquid crystal domain, the second liquid crystal domain, the third liquid crystal domain, and the fourth liquid crystal domain from below;
the second vertical alignment film includes a first upper alignment regulating portion, a second upper alignment regulating portion, a third upper alignment regulating portion, and a fourth upper alignment regulating portion to regulate alignments of the liquid crystal molecules in the first liquid crystal domain, the second liquid crystal domain, the third liquid crystal domain, and the fourth liquid crystal domain from above; and
the second and fourth lower alignment regulating portions and the second and fourth upper alignment regulating portions each include
a first high-pretilt angle region provided at one side in a direction along the longitudinal direction of the pixel region,
a second high-pretilt angle region provided at another side in the direction along the longitudinal direction of the pixel region, and
a low-pretilt angle region being provided between the first high-pretilt angle region and the second high-pretilt angle region and having a smaller pretilt angle than do the first and second high-pretilt angle regions, the production method comprising:
a step of forming the first vertical alignment film and the second vertical alignment film so that the first and second high-pretilt angle regions of the second lower alignment regulating portion are shorter in length than the first and second high-pretilt angle regions of the second upper alignment regulating portion in the direction along the longitudinal direction of the pixel region, and that the first and second high-pretilt angle regions of the fourth lower alignment regulating portion are shorter in length than the first and second high-pretilt angle regions of the fourth upper alignment regulating portion in the direction along the longitudinal direction of the pixel region; and
a step of, after the step of forming the first vertical alignment film and the second vertical alignment film is performed, disposing the second substrate on the first substrate section via the liquid crystal layer so that the first and second high-pretilt angle regions of the second lower alignment regulating portion are opposed to the first and second high-pretilt angle regions of the second upper alignment regulating portion, and that the first and second high-pretilt angle regions of the fourth lower alignment regulating portion are opposed to the first and second high-pretilt angle regions of the fourth upper alignment regulating portion.
